(19) United States
(12) Patent Application Publication
(10) Pub. No.: US 2025/0008334 A1
(43) Pub. Date: Jan. 2, 2025

(54) DYNAMIC WORKSITE DIRECTORY FOR GEOFENCED AREA

(71) Applicant: Weavix, Inc., Wichita, KS (US)

(72) Inventors: Kevin TURPIN, Wichita, KS (US); Benjamin BURRUS, Wichita, KS (US)

(21) Appl. No.: 18/677,194

(22) Filed: May 29, 2024

Related U.S. Application Data
(60) Provisional application No. 63/511,595, filed on Jun. 30, 2023.

(51) Int. Cl. H04W 12/64; H04W 4/021

(52) U.S. Cl. CPC H04W 12/64; H04W 4/021

(57) ABSTRACT

A method for dynamically updating a worksite-specific directory that harmonizes one or more team-specific directories. The method includes establishing permissions to access the one or more team-specific directories to populate the worksite-specific directory, establishing a geofence that defines a boundary for a worksite of the worksite-specific directory, which includes feature vector data for workers of the team-specific directories who are assigned to the worksite and are located within the geofenced area of the worksite. The method further includes adding links of the team-specific directories to the worksite-specific directory, tracking locations of workers based on locations of associated smart radios, and updating links in the worksite-specific directory based on the locations of the workers relative to the geofence of the worksite.

### CROSS-REFERENCE TO RELATED APPLICATIONS

This application claims the benefit of U.S. Provisional Patent Application Ser. No. 63/511,595, filed Jun. 30, 2023, which is incorporated by reference herein in its entirety.

### TECHNICAL FIELD

The present disclosure is generally related to wireless communication handsets and systems.

### BACKGROUND

Frontline workers often rely on radios to enable them to communicate with their team members. Traditional radios may fail to provide some communication services, requiring workers to carry additional devices to stay adequately connected to their team. Often, these devices are unfit for in-field use due to their fragile design or their lack of usability during frontline work. For example, smartphones, laptops, or tablets with additional communication capabilities may be easily damaged in the field, difficult to use in a dirty environment or when wearing protective equipment, or overly bulky for daily transportation on site. Accordingly, workers may be less accessible to their teams, which can lead to safety concerns and a decrease in productivity.

### BRIEF DESCRIPTION OF THE DRAWINGS

FIG. 1 is a block diagram illustrating an example architecture for an apparatus that enables device tracking relative to a worksite defined by a geofence.

FIG. 2 is a block diagram illustrating an example apparatus for device communication and tracking relative to a worksite defined by a geofence.

FIG. 3 is a block diagram illustrating an example charging station for apparatuses implementing device communication and tracking.

FIG. 4A is a block diagram illustrating example worksites for apparatuses and communication networks used for dynamic harmonization of directories.

FIG. 4B is a flow diagram illustrating an example process for generating a work experience profile.

FIG. 5 is a block diagram illustrating an example facility using apparatuses and communication networks for device communication and tracking.

FIG. 6 illustrates an example of a worksite that includes a plurality of geofenced areas.

FIG. 7 is a block diagram illustrating an example machine learning (ML) system.

FIG. 8 is an exemplary worksite-specific directory that dynamically synchronizes content of team-specific directories of separate organizations.

FIG. 9 illustrates a worksite directory that harmonizes team directories in a geofenced worksite.

FIG. 10 is a flow diagram that illustrates processes for dynamically updating a worksite-specific directory to harmonize team-specific directories.

FIG. 11 is a block diagram illustrating an example computer system, in accordance with one or more embodiments.

### DETAILED DESCRIPTION

A workplace electronic directory includes a list of records for respective individuals employed by a company. The directory can include comprehensive personal details about the individuals. Different portions of details are available to viewers depending on access rights that are granted by an administrator or policies. The details can include name, role, address, telephone numbers, location, contact information, education, experience, etc. For example, a viewer with full access rights can see all details about individuals, while a viewer with partial access rights can only view limited details about the individuals. In one example, only employees of a company have varying access rights to the company's private directory. In contrast, LinkedIn® is an example of a public, employment-focused directory that works through websites and mobile apps.

The systems and methods disclosed herein relate to dynamically synchronizing separate electronic directories that are hosted on a common platform. The platform can operate on a system that supports handheld mobile radio devices (e.g., smart radios) for different users on different teams. For example, all workers of a first construction crew are assigned a group of smart radios that support communications while assigned a job at a particular worksite. Each smart radio has an identifier that is associated with the current user. A server or system of an organization of the first construction crew can access or store information related to the smart radios and their users on its team-specific directory. The information can include the name of a current assignee of a smart radio, a level of responsibility, team assignment, current location of the device, etc.

In one example, a company that hires a first construction crew to work at a worksite requires access to worker information to, for example, supervise an ongoing project. The company may want to know the roles of different workers on the worksite to identify the supervisor of the construction crew should the company need to contact the supervisor to discuss an issue. The construction crew may also want to send information about its workers at the worksite to the company. The information can include, for example, that Alice, Bob, and Charlie are assigned to the project at the worksite and indicate their respective roles. The information received by the company, comprehensive and accurate though it may be, is typically static. Changes to the project or persons assigned to work on the project necessitate updating the original information. For example, Bob, the supervisor on the construction field, may rotate off the project, leaving Alice to be a replacement supervisor.

A change is not evident to the hiring company, causing confusion when the company tries to identify a responsible person on a team that is working at a worksite. Other day-to-day staffing changes can similarly occur. For example, two people on the same team and having the same role can swap for one or more days on occasion at the worksite. The processes for a hiring company to send, receive, and track changes to personnel and associated metadata is laborious and error-prone, particularly when there are multiple teams of different companies working at the same worksite (e.g., different types of crews on the same project). In addition, merely granting access to an electronic directory of a subordinate company to a hiring company fails to protect the privacy of personnel who are employed by the subordinate company but not assigned to the worksite of the hiring company.

Thus, private directories for organizations are comprehensive but not useful outside of the organizations. For example, a hiring company cannot readily identify which person having a supervisor role is assigned to handle the company's job. Further, workers leaving and/or entering organizations change the directories. The changes are exacerbated when integrating directories across multiple teams since only parts of a directory may be shared with a hiring company. Moreover, if different parts of a directory are shared, it can be burdensome to track which persons must be alerted of changes.

To address the problems illustrated in the above examples, systems and methods disclosed herein include a common platform that hosts personnel information in separate directories for respective organizations. The personnel information includes key features of workers (e.g., a role with a responsibility level on a team at a location). Viewing the personnel information in a directory requires access rights that are limited to the particular organizations to which the personnel belong. As such, the personnel information remains private. The personnel information includes associated smart radios that are assigned to them.

When hired as a subordinate company to a primary company, the subordinate company can grant the primary company access rights to the subordinate company's directory such that only that personnel information of workers associated with smart radios presently in a geofenced area of a worksite is available to the primary company. In one example, a team-specific directory is integrated into a worksite-specific directory and dynamically updates the person identified should one or more of those key features change. This enables the primary company to view and communicate with workers of the subordinate company who are at the worksite. For example, instead of the primary company requesting data for Bob, the request contains descriptions of the role and responsibilities that Bob happens to fill, e.g., construction chief for the first construction team. When Alice fills Bob's role as construction chief for the first construction team, the platform dynamically adjusts the information supplied to the primary company so that Alice's data is provided.

The platform is configured to host smart radios (e.g., mobile radio devices) that can be used to monitor the locations of the workers at specific worksites in real time. As the responsibilities of these workers adapt with technology, the functionality of the mobile radio devices must evolve to provide additional functionality. For example, mobile radio devices have been improved to increase connectivity in previously disconnected locations. Moreover, improvements in mobile radio devices enable workers to communicate through additional forms of communication, often without user intervention. Mobile radio devices thus provide a mechanism for tracking workers and equipment on a worksite to improve safety and efficiency. Mobile radio devices can further track details about employees during their work shift, and that information can be used to analyze the employees' strengths and weaknesses. Accordingly, the present disclosure relates to improvements in mobile radio devices to enable dynamic harmonization of directories based on the presence of the mobile radio devices at particular worksites. In general, the technology improves at least one of four technical aspects (“pillars”): network connectivity, collaboration, location services, and data, which are explained below.

Network connectivity: Smart radios operate using multiple onboard radios and connect to a set of known networks. This pillar refers to radio selection (e.g., use of multiple onboard radios in various contexts) and network selection (e.g., selecting which network to connect to from available networks in various contexts). These decisions may depend on data obtained from other pillars; however, inventions directed to the connectivity pillar have outputs that relate to improvements to network or radio communications/selections.

Collaboration: This pillar relates to communication between users of smart radios. A collaboration platform includes chat channel selection, audio transcription and interpretation, sentiment analysis, and workflow improvements. The associated smart radio devices further include interface features that improve ease of communication through reduction in button presses and hands-free information delivery. Technology in this pillar relates to improvements or gained efficiencies in communicating between users and/or the platform itself.

Location services: This pillar refers to various means of identifying the location of devices and people. There are straightforward or primary means, such as the Global Positioning System (GPS), accelerometer, or cellular triangulation. However, there are also secondary means by which known locations (via primary means) are used to derive the location of other unknown devices. For example, a set of smart radio devices with known locations is used to triangulate other devices or equipment. Further location services inventions relate to identification of the behavior of human users of the devices, e.g., micromotions of the device indicate that it is being worn, whereas lack of motion indicates that the device has been placed on a surface. Technology in this pillar relates to the identification of the physical location of objects or workers.

Data: This pillar relates to the “Internet of Workers” platform that hosts the smart radios. Each of the other pillars leads to the collection of data. Implementation of that data into models provides valuable insights that illustrate a given worksite to users who are not physically present at that worksite. Such insights include productivity of workers, experience of workers, and accident or hazard mapping. Technology in the data pillar relates to deriving insight or conclusions from one or more sources of data collected from any available sensor in the worksite.

Embodiments of the present disclosure will now be described with reference to the following figures. Although illustrated and described with respect to specific examples, embodiments of the present disclosure can be embodied in many different forms and should not be construed as limited to the embodiments set forth herein. Accordingly, the examples set forth herein are non-limiting examples referenced to improve the description of the present technology.

### Portable Wireless Apparatus

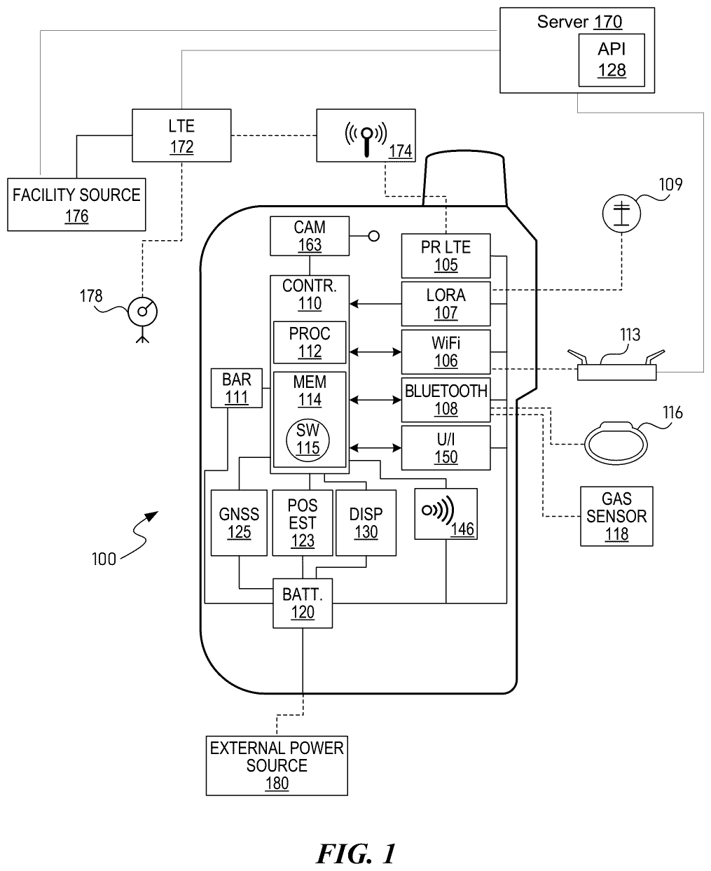

FIG. 1 is a block diagram illustrating an example architecture for an apparatus 100 for device communication and tracking, in accordance with one or more embodiments. The wireless apparatus 100 is implemented using components of the example computer system illustrated and described in more detail with reference to subsequent figures. In embodiments, the apparatus 100 is used to execute the ML system illustrated and described in more detail with reference to subsequent figures. The architecture shown by FIG. 1 is incorporated into a portable wireless apparatus 100, such as a smart radio, a smart camera, a smart watch, a smart headset, or a smart sensor. Although illustrated in a particular configuration, different embodiments of the apparatus 100 include different and/or additional components connected in different ways.

The apparatus 100 includes a controller 110 communicatively coupled either directly or indirectly to a variety of wireless communication arrangements. The apparatus 100 includes a position estimating component 123 (e.g., a dead-reckoning system), which estimates current position using inertia, speed, and intermittent known positions received from a position tracking component 125, which, in embodiments, is a Global Navigation Satellite System (GNSS) component. A battery 120 is electrically coupled with a cellular subsystem 105 (e.g., a private Long-Term Evolution (LTE) wireless communication subsystem), a Wi-Fi subsystem 106, a low-power wide area network (LPWAN) (e.g., LPWAN/long-range (LoRa) network subsystem 107), a Bluetooth subsystem 108, a barometer 111, an audio device 146, a user interface 150, and a built-in camera 163 for providing electrical power.

The battery 120 can be electrically and communicatively coupled with the controller 110 for providing electrical power to the controller 110 and to enable the controller 110 to determine a status of the battery 120 (e.g., a state of charge). In embodiments, the battery 120 is a non-removable rechargeable battery (e.g., using external power source 180). In this way, the battery 120 cannot be removed by a worker to power down the apparatus 100, or subsystems of the apparatus 100 (e.g., the position tracking component 125), thereby ensuring connectivity to the workforce throughout their shift. Moreover, the apparatus 100 cannot be disconnected from the network by removing the battery 120, thereby reducing the likelihood of device theft. In some cases, the apparatus 100 can include an additional, removable battery to enable the apparatus 100 to be used for prolonged periods without requiring additional charging time.

The controller 110 is, for example, a computer having a memory 114, including a non-transitory storage medium for storing software 115, and a processor 112 for executing instructions of the software 115. In some embodiments, the controller 110 is a microcontroller, a microprocessor, an integrated circuit (IC), or a system-on-a-chip (SoC). The controller 110 can include at least one clock capable of providing time stamps or displaying time via display 130. The at least one clock can be updatable (e.g., via the user interface 150, the position tracking component 125, the Wi-Fi subsystem 106, the private cellular network 107 subsystem, a server, or a combination thereof).

The wireless communications arrangement can include a cellular subsystem 105, a Wi-Fi subsystem 106, a LPWAN/LoRa network subsystem 107 wirelessly connected to a LPWAN network 109, or a Bluetooth subsystem 108 enabling sending and receiving. Cellular subsystem 105, in embodiments, enables the apparatus 100 to communicate with at least one wireless antenna 174 located at a facility (e.g., a manufacturing facility, a refinery, or a construction site), examples of which may be illustrated in and described with respect to the subsequent figures.

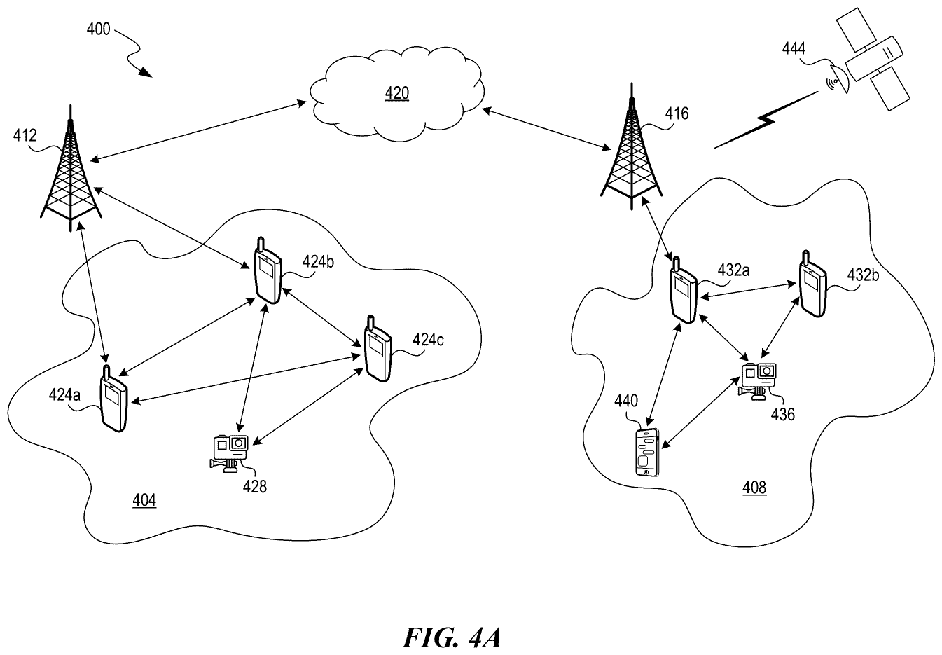

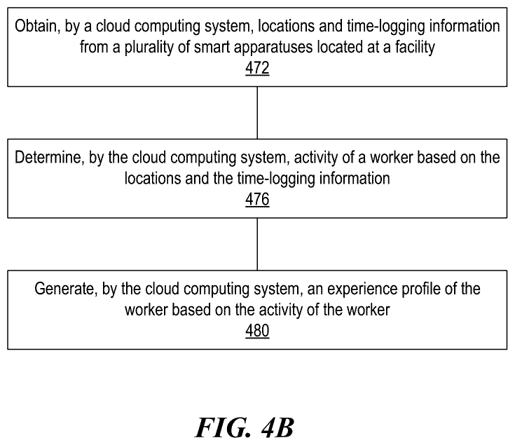

In embodiments, a cellular edge router arrangement 172 is provided for implementing a common wireless source. The cellular edge router arrangement 172 (sometimes referred to as an “edge kit”) can provide a wireless connection to the Internet. In embodiments, the LPWAN network 109, the wireless cellular network, or a local radio network is implemented as a local network for the facility usable by instances of the apparatus 100 (e.g., local network 404 illustrated in FIG. 4A). For example, the cellular type can be 2G, 3G, 4G, LTE, 5G, etc. The edge kit 172 is typically located near a facility's primary Internet source 176 (e.g., a fiber backhaul or other similar device). Alternatively, a local network of the facility is configured to connect to the Internet using signals from a satellite source, transceiver, or router 178, especially in a remotely located facility not having a backhaul source, or where a mobile arrangement not requiring a wired connection is desired. More specifically, the satellite source plus edge kit 172 is, in embodiments, configured into a vehicle, or portable system. In embodiments, the cellular subsystem 105 is incorporated into a local or distributed cellular network operating on any of the existing 88 different Evolved Universal Mobile Telecommunications System Terrestrial Radio Access (EUTRA) operating bands (ranging from 700 MHz up to 2.7 GHZ). For example, the apparatus 100 can operate using a duplex mode implemented using time division duplexing (TDD) or frequency division duplexing (FDD).

The Wi-Fi subsystem 106 enables the apparatus 100 to communicate with an access point 113 capable of transmitting and receiving data wirelessly in a relatively high-frequency band. In embodiments, the Wi-Fi subsystem 106 is also used in testing the apparatus 100 prior to deployment. The Bluetooth subsystem 108 enables the apparatus 100 to communicate with a variety of peripheral devices, including a biometric interface device 116 and a gas/chemical detection sensor 118 used to detect noxious gases. In embodiments, numerous other Bluetooth devices are incorporated into the apparatus 100.

As used herein, the wireless subsystems of the apparatus 100 include any wireless technologies used by the apparatus 100 to communicate wirelessly (e.g., via radio waves) with other apparatuses in a facility (e.g., multiple sensors, a remote interface, etc.), and optionally with the Internet (“the cloud”) for accessing websites, databases, etc. For example, the apparatus 100 can be capable of connecting with a conference call or video conference at a remote conferencing server. The apparatus 100 can interface with a conferencing software (e.g., Microsoft Teams™, Skype™, Zoom™, Cisco Webex™). The wireless subsystems 105, 106, and 108 are each configured to transmit/receive data in an appropriate format, for example, in IEEE 802.11, 802.15, 802.16 Wi-Fi standards, Bluetooth standard, WinnForum Spectrum Access System (SAS) test specification (WINNF-TS-0065), and across a desired range. In embodiments, multiple mobile radio devices are connected to provide data connectivity and data sharing. In embodiments, the shared connectivity is used to establish a mesh network.

The apparatus 100 communicates with a host server 170 which includes API software 128. The apparatus 100 communicates with the host server 170 via the Internet using pathways such as the Wi-Fi subsystem 106 through an access point 113 and/or the wireless antenna 174. The API 128 communicates with onboard software 115 to execute features disclosed herein.

The position tracking component 125 and the position estimating component 123 operate in concert. The position tracking component 125 is used to track the location of the apparatus 100. In embodiments, the position tracking component 125 is a GNSS (e.g., GPS, Quasi-Zenith Satellite System (QZSS), BEIDOU, GALILEO, GLONASS) navigational device that receives information from satellites and determines a geographic position based on the received information. The position determined from the GNSS navigation device can be augmented with location estimates based on waves received from proximate devices. For example, the position tracking component 125 can determine a location of the apparatus 100 relative to one or more proximate devices using receives signal strength indicator (RSSI) techniques, time difference of arrival (TDOA) techniques, or any other appropriate techniques. The relative position can then be combined with the position of the proximate devices to determine a location estimate of the apparatus 100, which can be used to augment or replace other location estimates. In embodiments, a geographic position is determined at regular intervals (e.g., every five minutes, every minute, every five seconds), and the position in between readings is estimated using the position estimating component 123.

Position data is stored in memory 114 and uploaded to server at regular intervals (e.g., every five minutes, every minute, every five seconds). In embodiments, the intervals for recording and uploading position data are configurable. For example, if the apparatus 100 is stationary for a predetermined duration, the intervals are ignored or extended, and new location information is not stored or uploaded. If no connectivity exists for wirelessly communicating with server 170, location data can be stored in memory 114 until connectivity is restored, at which time the data is uploaded and then deleted from memory 114. In embodiments, position data is used to determine latitude, longitude, altitude, speed, heading, and Greenwich mean time (GMT), for example, based on instructions of software 115 or based on external software (e.g., in connection with server 170). In embodiments, position information is used to monitor worker efficiency, overtime, compliance, and safety, as well as to verify time records and adherence to company policies.

In some embodiments, a Bluetooth tracking arrangement using beacons is used for position tracking and estimation. For example, the Bluetooth subsystem 108 receives signals from Bluetooth Low Energy (BLE) beacons located about the facility. The controller 110 is programmed to execute relational distancing software using beacon signals (e.g., triangulating between beacon distance information) to determine the position of the apparatus 100. Regardless of the process, the Bluetooth subsystem 108 detects the beacon signals and the controller 110 determines the distances used in estimating the location of the apparatus 100.

In alternative embodiments, the apparatus 100 uses Ultra-Wideband (UWB) technology with spaced-apart beacons for position tracking and estimation. The beacons are small, battery-powered sensors that are spaced apart in the facility and broadcast signals received by a UWB component included in the apparatus 100. A worker's position is monitored throughout the facility over time when the worker is carrying or wearing the apparatus 100. As described herein, location-sensing GNSS and estimating systems (e.g., the position tracking component 125 and the position estimating component 123) can be used to primarily determine a horizontal location. In embodiments, the barometer 111 is used to determine a height at which the apparatus 100 is located (or operates in concert with the GNSS to determine the height) using known vertical barometric pressures at the facility. With the addition of a sensed height, a full three-dimensional location is determined by the processor 112. Applications of the embodiments include determining if a worker is, for example, on stairs or a ladder, atop or elevated inside a vessel, or in other relevant locations.

In embodiments, the display 130 is a touch screen implemented using a liquid-crystal display (LCD), an e-ink display, an organic light-emitting diode (OLED), or other digital display capable of displaying text and images. In embodiments, the display 130 uses a low-power display technology, such as an e-ink display, for reduced power consumption. Images displayed using the display 130 include, but are not limited to, photographs, video, text, icons, symbols, flowcharts, instructions, cues, and warnings.

The audio device 146 optionally includes at least one microphone (not shown) and a speaker for receiving and transmitting audible sounds, respectively. Although only one audio device 146 is shown in the architecture drawing of FIG. 1, it should be understood that in an actual physical embodiment, multiple speakers or microphones can be utilized to enable the apparatus 100 to adequately receive and transmit audio. In embodiments, the speaker has an output around 105 dB to be loud enough to be heard by a worker in a noisy facility. The microphone of the audio device 146 receives the spoken sounds and transmits signals representative of the sounds to the controller 110 for processing.

The apparatus 100 can be a shared device that is assigned to a particular user temporarily (e.g., for a shift). In embodiments, the apparatus 100 communicates with a worker ID badge using near field communication (NFC) technology. In this way, a worker may log in to a profile (e.g., stored at a remote server) on the apparatus 100 through their worker ID badge. The worker's profile may store information related to the worker. Examples include name, employee or contractor serial number, login credentials, emergency contact(s), address, shifts, roles (e.g., crane operator), calendars, or any other professional or personal information. Moreover, the user, when logged in, can be associated with the apparatus 100. When another user logs in to the apparatus 100, however, that user can then be associated with the apparatus 100.

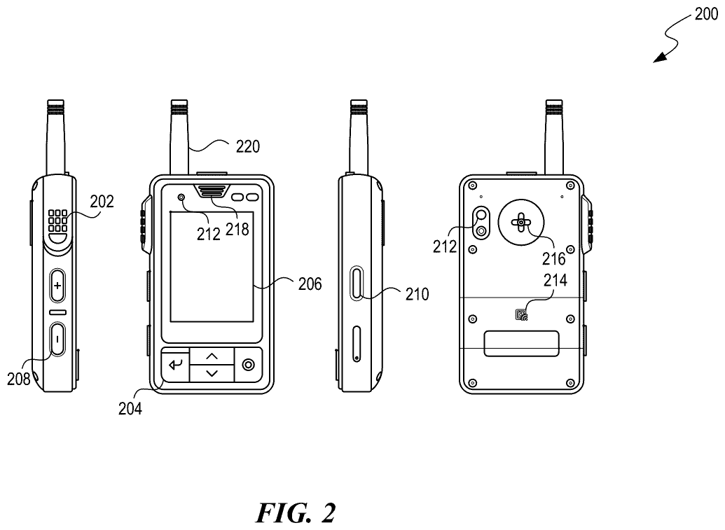

FIG. 2 is a drawing illustrating an example apparatus 200 for device communication and tracking relative to a worksite defined by a geofence. The apparatus 200 includes a user interface that includes a PTT button 202, a 4-button user input system 204, a display 206, an easy to grab volume control 208, and a power button 210. The PTT button 202 can be used to control the transmission of data from or the reception of data by the apparatus 200. For example, the apparatus 200 may transmit audio data or other data when the PTT button 202 is pressed and receive audio data or other data when the PTT button 202 is released. In other examples, the PTT button 202 may control the transmission of audio data or other data from the apparatus 200 (e.g., transmit when the PTT button 202 is pressed), though apparatus 200 may transmit and receive audio data or other data at the same time (e.g., full duplex communication). The 4-button user input system 204 can be used to interact with the apparatus 200. For example, the 4-button user input system 204 can be used as a 4-direction input system (e.g., up-down-left-right), a 2-directional-enter-back (e.g., up-down-enter-back), or any other button configuration. The display 206 can output relevant visual information to the user. In aspects, the display 206 can enable touch input by the user to control the apparatus 200. The volume control 208 can control the loudness of the apparatus 200. The power button 210 can turn the apparatus 200 on and off.

The apparatus 200 further includes at least one camera 212, an NFC tag 214, a mount 216, at least one speaker 218, and at least one antenna 220. The camera 212 can be implemented as a front camera capturing the environment in front of the display 206 or a back camera capturing the environment opposite the display 206. The NFC tag 214 can be used to connect or register the apparatus 200. For example, the NFC tag 214 can register the apparatus 200 as being docked in a charging station. In yet another example, the NFC tag can connect to a workers badge to associate the apparatus with the worker. The mount 216 can be used to attach the apparatus 200 to the worker (e.g., on a utility belt of the worker). The speaker 218 can output audio received by or presented on the apparatus 200. The volume of the speaker 218 can be controlled by the volume control 208. The antenna 220 can be used to transmit data from the apparatus 200 or receive data at the apparatus 200. In some cases, transmission or reception by the antenna 220 can be controlled by the PTT button 202 or another button of the user interface.

### Charging Station

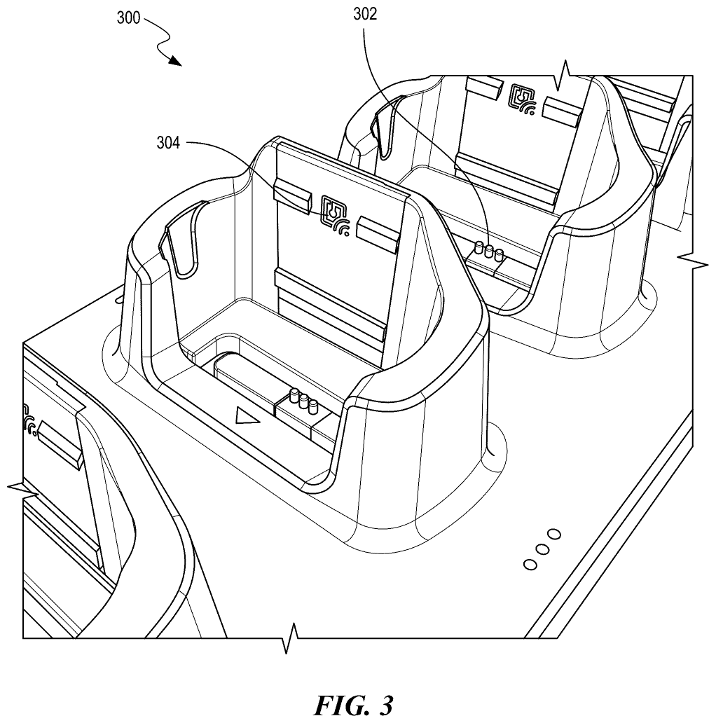

FIG. 3 is a drawing illustrating an example charging station 300 for apparatuses implementing device communication and tracking. The charging station 300 can be used to dock one or more mobile radio devices for charging. In aspects, power can be supplied to the mobile radio devices docked at the charging station 300 through charging pins 302 located in each receptacle of the charging station 300. The charging pins 302 can be inserted into a charging port of the mobile radio devices. A worker clocking out at a facility can place a mobile radio device into the charging station 300. The mobile radio device can remain docked until it is removed from the charging station 300 by a worker clocking in at the facility.

The charging station 300 or the mobile radio device can determine when the mobile radio device has been docked in the charging station 300. For example, each receptacle of the charging station 300 can have an NFC pad 304 that connects with the mobile radio device when the mobile radio device is docked in that receptacle of the charging station 300. Alternatively or additionally, the mobile radio device can be determined to be docked in the charging station 300 when the charging pins 302 of a receptacle are inserted into the mobile radio device. In these ways, a cloud computing system can be made aware of the location and status (e.g., docked or removed) of the mobile radio device through communication with the charging station 300 or the mobile radio device.

### Communication Network

FIG. 4A is a drawing illustrating an example environment 400 for apparatuses and communication networks for device communication, tracking, and geofencing. The environment 400 includes a cloud computing system 420, cellular transmission towers 412, 416, and local networks 404, 408 of respective worksites. Components of the environment 400 are implemented using components of the example computer system illustrated and described in more detail with reference to subsequent figures. Likewise, different embodiments of the apparatus 100 include different and/or additional components and are connected in different ways.

Smart radios 424 (e.g., smart radios 424a-424c), smart radios 432 (e.g., smart radios 432a-b) and smart cameras 428, 436 are implemented in accordance with the architecture shown by FIG. 1. In embodiments, smart sensors implemented in accordance with the architecture shown by FIG. 1 are also connected to the local networks 404, 408 and mounted on a surface of a worksite, or worn or carried by workers. For example, the local network 404 is located at a first facility and the local network 408 is at a second facility. In embodiments, each smart radio and other smart apparatus has two Subscriber Identity Module (SIM) cards, sometimes referred to as dual SIM. A SIM card is an IC intended to securely store an international mobile subscriber identity (IMSI) number and its related key, which are used to identify and authenticate subscribers on mobile telephony devices.

A first SIM card enables the smart radio 424a to connect to the local (e.g., cellular) network 404 and a second SIM card enables the smart radio 424a to connect to a commercial cellular tower (e.g., cellular transmission tower 412) for access to mobile telephony, the Internet, and the cloud computing system 420 (e.g., to major participating networks such as Verizon™, AT&T™, or T-Mobile™). In such embodiments, the smart radio 424a has two radio transceivers, one for each SIM card. In other embodiments, the smart radio 424a has two active SIM cards, and the SIM cards both use only one radio transceiver. However, the two SIM cards are both active only as long as both are not in simultaneous use. As long as the SIM cards are both in standby mode, a voice call could be initiated on either one. However, once the call begins, the other SIM card becomes inactive until the first SIM card is no longer actively used.

In embodiments, the local network 404 uses a private address space of Internet protocol (IP) addresses. In other embodiments, the local network 404 is a local radio-based network using peer-to-peer (P2P) two-way radio (duplex communication) with extended range based on hops (e.g., from smart radio 424a to smart radio 424b to smart radio 424c). Hence, radio communication is transferred similarly to addressed packet-based data with packet switching by each smart radio or other smart apparatus on the path from source to destination. For example, each smart radio or other smart apparatus operates as a transmitter, receiver, or transceiver for the local network 404 to serve a facility of a worksite. The smart apparatuses serve as multiple transmit/receive sites interconnected to achieve the range of coverage required by the facility. Further, the signals on the local networks 404, 408 are backhauled to a central switch for communication to the cellular transmission towers 412, 416.

In embodiments (e.g., in more remote locations), the local network 404 is implemented by sending radio signals between multiple smart radios 424. Such embodiments are implemented in less-inhabited locations (e.g., wilderness) where workers are spread out over a larger work area that may be otherwise inaccessible to commercial cellular service. An example is where power company technicians are examining or otherwise working on power lines over larger distances that are often remote. The embodiments are implemented by transmitting radio signals from a smart radio 424a to other smart radios 424b, 424c on one or more frequency channels operating as a two-way radio. The radio messages sent include a header and a payload. Such broadcasting does not require a session or a connection between the devices. Data in the header is used by a receiving smart radio 424b to direct the “packet” to a destination (e.g., smart radio 424c). At the destination, the payload is extracted and played back by the smart radio 424c via the radio's speaker.

For example, the smart radio 424a broadcasts voice data using radio signals. Any other smart radio 424b within a range limit (e.g., 1 mile, 2 miles) receives the radio signals. The radio data includes a header having the destination of the message (smart radio 424c). The radio message is decrypted/decoded and played back on only the destination smart radio 424c. If another smart radio 424b that was not the destination radio receives the radio signals, the smart radio 424b rebroadcasts the radio signals rather than decoding and playing them back on a speaker. The smart radios 424 are thus used as signal repeaters. The advantages and benefits of the embodiments disclosed herein include extending the range of two-way radios or smart radios 424 by implementing radio hopping between the radios.

In embodiments, the local network 404 of a worksite is implemented using Citizens Broadband Radio Service (CBRS). The use of CBRS Band 48 (from 3550 MHz to 3700 MHZ), in embodiments, provides numerous advantages. For example, the use of CBRS Band 48 provides longer signal ranges and smoother handovers. The use of CBRS Band 48 supports numerous smart radios 424 and smart cameras 428 at the same time. A smart apparatus is therefore sometimes referred to as a Citizens Broadband Radio Service Device (CBSD). To enable CBRS, the controller 110 includes multiple computing and other devices, in addition to those depicted (e.g., multiple processing and memory components relating to signal handling). The controller 110 is illustrated and described in more detail with reference to FIG. 1. For example, the private network component 105 (illustrated and described in more detail with reference to FIG. 1) includes numerous components related to supporting cellular network connectivity (e.g., antenna arrangements and supporting processing equipment configured to enable CBRS). The use of CBRS Band 48 (from 3550 MHz to 3700 MHZ), in embodiments, provides numerous advantages. For example, the use of Band 48 provides longer signal ranges and smoother handovers. The use of CBRS Band 48 supports numerous smart radios 224 and smart cameras 228 at the same time. A smart apparatus is therefore sometimes referred to as a CBSD.

In alternative embodiments, the Industrial, Scientific, and Medical (ISM) radio bands are used instead of CBRS Band 48. It should be noted that the particular frequency bands used in executing the processes herein could be different, and that the aspects of what is disclosed herein should not be limited to a particular frequency band unless otherwise specified (e.g., 4G-LTE or 5G bands could be used). In embodiments, the local network 404 is a private cellular (e.g., LTE) network operated specifically for the benefit of the facility. Only authorized users of the smart radios 424 have access to the local network 404. For example, the local network 404 uses the 900 MHz spectrum. In another example, the local network 404 uses 900 MHz for voice and narrowband data for Land Mobile Radio (LMR) communications, 900 MHz broadband for critical wide area, long-range data communications, and CBRS for ultra-fast coverage of smaller areas of the facility, such as substations, storage yards, and office spaces.

The smart radios 424 can communicate using other communication technologies, for example, Voice over IP (VOIP), Voice over Wi-Fi (VoWiFi), or Voice over Long-Term Evolution (VOLTE). The smart radios 424 can connect to a communication session (e.g., voice call, video call) for real-time communication with specific devices. The communication sessions can include devices within or outside of the local network 404 (e.g., in the local network 408). The communication sessions can be hosted on a private server (e.g., of the local network 404) or a remote server (e.g., accessible through the cloud computing system 420). In other aspects, the session can be P2P.

The cloud computing system 420 delivers computing services-including servers, storage, databases, networking, software, analytics, and intelligence-over the Internet to offer faster innovation, flexible resources, and economies of scale. FIG. 4A depicts an exemplary high-level, cloud-centered network environment 400 otherwise known as a cloud-based system. Referring to FIG. 4A, it can be seen that the environment centers around the cloud computing system 420 and the local networks 404, 408. Through the cloud computing system 420, multiple software systems are made to be accessible by multiple smart radios 424, 432, smart cameras 428, 436, as well as more standard devices (e.g., a smartphone 440 or a tablet) each equipped with local networking and cellular wireless capabilities. Each of the apparatuses 424, 428, 440, although diverse, can embody the architecture of the apparatus 100 shown by FIG. 1, but are distributed to different kinds of users or mounted on surfaces of the facility. For example, the smart radio 424a is worn by employees or independently contracted workers at a facility. The CBRS-equipped smartphone 440 is utilized by an on- or offsite supervisor. The smart camera 428 is utilized by an inspector or another person wanting to have improved display or other options. Regardless, it should be recognized that numerous apparatuses are utilized in combination with an established cellular network (e.g., CBRS Band 48 in embodiments) to provide the ability to access the cloud software applications from the apparatuses (e.g., smart radios 424, 432, smart cameras 428, 436, smartphone 440).

In embodiments, the cloud computing system 420 and local networks 404, 408 are configured to send communications to the smart radios 424, 432 or smart cameras 428, 436 based on analysis conducted by the cloud computing system 420. The communications enable the smart radio 424 or smart camera 428 to receive warnings, etc., generated as a result of analysis conducted. The employee-worn smart radio 424a (and possibly other devices including the architecture of the apparatus 100, such as the smart cameras 428, 436) is used along with the peripherals shown in FIG. 1 to accomplish a variety of objectives. For example, workers, in embodiments, are equipped with a Bluetooth-enabled gas-detection smart sensor. The smart sensor detects the existence of a dangerous gas, or gas level. By connecting through the smart radio 424a or directly to the local network 404, the readings from the smart sensor are analyzed by the cloud computing system 420 to implement a course of action due to sensed characteristics of toxicity. The cloud computing system 420 sends out an alert to the smart radio 424 or smart camera 428, and thus a worker, for example, uses a speaker or alternative notification means to alert other workers so that they can avoid danger.

### Position Estimation

The environment 400 can include one or more satellites 444. The smart radios 424 can receive signals from the satellites 444 that are usable to determine position estimates. For example, the smart radios 424 include a positioning system that implements a GNSS or other network triangulation/position system. In some embodiments, the locations of the smart radios 424 are determined from satellites, for example, GPS, QZSS, BEIDOU, GALILEO, and GLONASS. In some cases, the position determined from the primary positioning system does not satisfy a minimum accuracy requirement, the primary position can only be determined at predetermined intervals, or the primary position cannot be determined at all. Accordingly, additional positioning techniques can be used to augment or replace primary positioning. For example, the smart radio 424a can track its position based on broadcast signals received from proximate devices (e.g., using RSSI techniques or TDOA techniques). In some embodiments, the proximate devices include devices that have transmission ranges that encompass the location of the smart radio 424a (e.g., smart radios 424b, 424c). In some embodiments, the smart radios 424 determine or augment a secondary position estimate based on broadcasts received from a cellular communication tower (e.g., cellular transmission tower 412).

RSSI techniques include using the strength signals within a broadcast signal to determine the distance of a receiver from a transmitter. For instance, a receiver is enabled to determine the signal-to-noise ratio (SNR) of a received signal within a broadcast from a transmitter. The SNR of receive signal can be related to the distance between a receiver and a transmitter. Thus, the distance between the receiver and the transmitter can be estimated based on the SNR. By determining a receiver's distance from multiple transmitters, the receiver's position can be determined through localization (e.g., triangulation). In some cases, RSSI techniques become less accurate at larger distances. Accordingly, proximate devices may be required to be within a particular distance for RSSI techniques.

TDOA techniques include using the timing at which broadcast signals are received to determine the distance of a receiver from a transmitter. For example, a broadcast signal is sent by a transmitter at a known time (e.g., predetermined intervals). Thus, by determining the time at which the broadcast signal is received (e.g., using a clock), the travel time of the broadcast signal can be determined. The distance of the smart radios 424 from one another can thus be determined based on the wave speed. In some implementations, as broadcast signals are received from the transmitters, the smart radios 424 determine its relative position from each transmitter through localization, resulting in a more accurate global position (e.g., triangulation). Thus, TDOA techniques can be used to determine device location.

In aspects, the broadcast signals transmitted by proximate devices include information related to a position. For example, broadcast signals sent from the smart radios 424 identify their current location. Broadcast signals sent from cellular communication towers or other stationary devices may not need to include a current location, as the location may be known to the receiving device. In other cases, a cellular communication tower or other stationary device sends a broadcast signal that includes information indicative of a current location of the tower or stationary device. Using the current location of the transmitting devices and the location of the smart radios (e.g., smart radios 424b, 424c) relative to the transmitting devices, a global position of the smart radio 424a can be determined.

In some cases, a barometer is used to augment the position determination of the smart radios 424. For example, RSSI, TDOA, and other techniques are used to determine the distance between a transmitter and a receiver. However, these techniques may not provide information related to the displacement between the transmitter and the receiver (e.g., whether the distance is in the x, y, or z plane). In some cases, the barometer is used to provide relative displacement information (e.g., based on atmospheric conditions) of the smart radios 424. In aspects, the broadcast signals received from the proximate devices include information relating to respective elevation estimates (e.g., determined by barometers at the proximate devices) at each of the proximate devices. The elevation estimates from the proximate devices are compared to the elevation estimate of the smart radio 424a to determine the difference in elevation between the smart radio 424a and the proximate devices (e.g., smart radios 424b, 424c).

In some cases, a target device estimates a location based on proximate devices without analyzing broadcast signals. For example, proximate devices shares their calculated location data. The target device (e.g., smart radio 424a) receives location data via any communication technology (e.g., Bluetooth or another short-range communication). One device (e.g., smart radio 424b) shares that it is at location A and another device (e.g., smart radio 424c) is at location B. The target device estimates that it's located somewhere near A and B (e.g., within a communication range of A and B using the respective communication mechanism). In another aspect, the target device receives location data from multiple proximate devices and combines (e.g., average) the location data to estimate its position. In yet another example, the target device receives location data from proximate devices via a first communication and uses a second communication to determine the location of the target device relative to the proximate devices. In this way, the location data need not be communicated in the same communication used to determine the relative location of the target device.

As an example, the smart radio 424b determines its location based on a primary location estimate that is augmented with a secondary location estimate. For example, the smart radio 424b receives a primary location estimate. In aspects, the primary location estimate is a GNSS location determined from the satellite 444 or a location estimate determined by communications with the cellular communication tower 412 (e.g., using TDOA, RSSI, or other techniques). In some implementations, the primary location estimate has a measurement error less than 1 foot, 2 feet, 5 feet, 10 feet, or the like. The measurement error may increase based on an environment of the smart radio 424b. For example, the measurement error may be higher if the smart radio 424b is within or surrounded by a densely constructed building.

To improve the measurement accuracy, the smart radio 424b can augment its primary location estimate based on a secondary location estimate. In aspects, the secondary location estimate is determined from broadcast signals transmitted by smart radio 424a, smart radio 424c, smart camera 428, cellular communication tower 412, or another communication device or node (e.g., an access point). Positioning techniques (e.g., TDOA, RSSI, location sharing, or other techniques) can be used to determine a relative distance from the transmitting device. For example, smart radio 424a, smart radio 424c, and smart camera 428 transmit broadcast signals that enable the distance of the smart radio 424b to be determined relative to each transmitting device. The transmitting devices can be stationary or moving. Stationary objects typically have strong or high confidence location data (e.g., immobile objects are plotted accurately to maps). The relative location of the smart radio 424b is determined through triangulation based on the distance from each transmitting device. In aspects, the secondary location estimate has a measurement error of less than 1 inch, 2 inches, 6 inches, or 1 foot. In aspects, the secondary location estimate replaces with the primary location estimate or is averaged with the primary location estimate to determine an augmented position estimate with reduced error. Accordingly, the measurement error of the location estimate of the smart radio device 424b can be improved by augmenting the primary location estimate with the secondary location estimate.

In some implementations, The location of the equipment is similarly monitored. In this context, mobile equipment refers to worksite or facility industrial equipment (e.g., heavy machinery, precision tools, construction vehicles). According to example embodiments, a location of a mobile equipment is continuously monitored based on repeated triangulation from multiple smart radios 424 located near the mobile equipment (e.g., using tags placed on the mobile equipment). Improvements to the operation and usage of the mobile equipment are made based on analyzing the locations of the mobile equipment throughout a facility or worksite. Locations of the mobile equipment are reported to owners of the mobile equipment or entities that own, operate, and/or maintain the mobile equipment. Mobile equipment whose location is tracked includes vehicles, tools used and shared by workers in different facility locations, toolkits and toolboxes, manufactured and/or packaged products, and/or the like. Generally, mobile equipment is movable between different locations within the facility or worksite at different points in time.

Various monitoring operations are performed based on the locations of the mobile equipment that are determined over time. In some embodiments, a usage level for the mobile equipment is automatically classified based on different locations of the mobile equipment over time. For example, a mobile equipment having frequent changes in location within a window of time (e.g., different locations that are at least a threshold distance away from each other) is classified at a high usage level compared to a mobile equipment that remains in approximately the same location for the window of time. In some embodiments, certain mobile equipment classified with high usage levels are indicated and identified to maintenance workers such that usage-related failures or faults can be preemptively identified.

In some embodiments, a resting or storage location for the mobile equipment is determined based on the monitoring of the mobile equipment location. For example, an average spatial location is determined from the locations of the mobile equipment over time. A storage location based on the average spatial location is then indicated in a recommendation provided or displayed to an administrator or other entity that manages the facility or worksite.

In some embodiments, locations of multiple mobile equipment are monitored so that a particular mobile equipment is recommended for use to a worker during certain events or scenarios. As another example, for a worker assigned with a maintenance task at a location within a facility, one or more maintenance toolkits shared among workers and located near the location are recommended to the worker for use.

Accordingly, embodiments described herein provide local detection and monitoring of mobile equipment locations. Facility operation efficiency is improved based on the monitoring of mobile equipment locations and analysis of different mobile equipment locations.

### Machine-Defined Interactions

The cloud computing system 420 uses data received from the smart radios 424, 432 and smart cameras 428, 436 to track and monitor machine-defined activity of workers based on locations worked, times worked, analysis of video received from the smart cameras 428, 436, etc. The activity is measured by the cloud computing system 420 in terms of at least one of a start time, a duration of the activity, an end time, an identity (e.g., serial number, employee number, name, seniority level, etc.) of the worker performing the activity, an identity of the equipment(s) used by the worker, or a location of the activity. For example, a smart radio 424a carried or worn by a worker would track that the position of the smart radio 424a is in proximity to or coincides with a position of the particular machine.

The activity is measured by the cloud computing system 420 in terms of at least the location of the activity and one of a duration of the activity, an identity of the worker performing the activity, or an identity of the equipment(s) used by the worker. In embodiments, the ML system is used to detect and track activity, for example, by extracting features based on equipment types or manufacturing operation types as input data. For example, a smart sensor mounted on an oil rig transmits to and receives signals from a smart radio 424a carried or worn by a worker to log the time the worker spends at a portion of the oil rig.

Worker activity involving multiple workers can similarly be monitored. These activities can be measured by the cloud computing system 420 in terms of at least one of a start time, a duration of the activity, an end time, identities (e.g., serial numbers, employee numbers, names, seniority levels, etc.) of the workers performing the activity, an identity of the equipment(s) used by the workers, or a location of the activity. Group activities are detected and monitored using location tracking of multiple smart apparatuses. For example, the cloud computing system 420 tracks and records a specific group activity based on determining that two or more smart radios 424 were located in proximity to one another within a particular worksite for a predetermined period of time. For example, a smart radio 424a transmits to and receives signals from other smart radios 424b, 424c carried or worn by other workers to log the time the worker spends working together in a team with the other workers.

In embodiments, a smart camera 428 mounted at the worksite captures video of one or more workers working in the facility and performs facial recognition (e.g., using the ML system). The smart camera 428 can identify the equipment used to perform an activity or the tasks that a worker is performing. The smart camera 428 sends the location information to the cloud computing system 420 for generation of activity data. In embodiments, an ML system is used to detect and track activity (e.g., using features based on geographic locations or facility types as input data).

The cloud computing system 420 can determine various metrics for monitored workers based on the activity data. For example, the cloud computing system 420 can determine a response time for a worker. The response time refers to the time difference between receiving a call to report to a given task and the time of arriving at a geofence associated with the task. In aspects, the cloud computing system 420 can determine a repair metric, which measures the effectiveness of repairs by a worker, based on the activity data. For example, the effectiveness of repairs is machine observable based on a length of time a given object remains functional as compared to an expected time of functionality (e.g., a day, a few months, a year, etc.). In yet another aspect, the activity data can be analyzed to determine efficient routes to different areas of a worksite, for example, based on routes traveled by monitored workers. Activity data can be analyzed to determine the risk to which each worker is exposed, for example, based on how much time a worker spends in proximity to hazardous material or performing hazardous tasks. The ML system can analyze the various metrics to monitor workers or reduce risk.

### Worker Experience Profile

The cloud computing system 420 hosts the software functions to track activities to determine performance metrics and time spent at different tasks and with different equipment and to generate work experience profiles of frontline workers based on interfacing between software suites of the cloud computing system 420 and the smart radios 424, 432, smart cameras 428, 436, smartphone 440. Tracking of activities is implemented in, for example, Scheduling Systems (SS), Field Data Management (FDM) systems, and/or Enterprise Resource Planning (ERP) software systems that are used to track and plan for the use of facility equipment and other resources. Manufacturing Management System (MMS) software is used to manage the production and logistics processes in manufacturing industries (e.g., for the purpose of reducing waste, improving maintenance processes and timing, etc.). Risk-Based Inspection (RBI) software assists the facility using optimized maintenance business processes to examine equipment and/or structures, and track activities prior to and after a breakdown in equipment, detection of manufacturing failures, or detection of operational hazards (e.g., detection of gas leaks in the facility). The amount of time each worker logs at a machine-defined activity with respect to different locations and different types of equipment is collected and used to update an “experience profile” of the worker on the cloud computing system 420 in real time.

FIG. 4B is a flow diagram illustrating an example process for generating a work experience profile using smart radios 424a, 424b, and local networks 404, 408 for device communication and tracking, in accordance with one or more embodiments. The smart radios 424 and local networks 404, 408 are illustrated and described in more detail with reference to FIG. 4A. In embodiments, the process of FIG. 4B is performed by the cloud computing system 420 illustrated and described in more detail with reference to FIG. 4A. In embodiments, the process of FIG. 4A is performed by a computer system, for example, the example computer system illustrated and described in more detail with reference to subsequent figures. Particular entities, for example, the smart radios 424 or the local network 404, perform some or all of the steps of the process in embodiments. Likewise, embodiments can include different and/or additional steps, or perform the steps in different orders.

At 472, the cloud computing system 420 obtains locations and time-logging information from multiple smart apparatuses (e.g., smart radios 424) located at a facility. The locations describe movement of the multiple smart apparatuses with respect to the time-logging information. For example, the cloud computing system 420 keeps track of shifts, types of equipment, and locations worked by each worker, and uses the information to develop the experience profile automatically for the worker, including formatting services. When the worker joins an employer or otherwise signs up for the service, relevant personal information is obtained by the cloud computing system 420 to establish payroll and other known employment particulars. The worker uses a smart radio 424a to engage with the cloud computing system 420 and works shifts for different positions.

At 476, the cloud computing system 420 determines activity of a worker based on the locations and the time-logging information. The activities describe work performed by one or more workers with equipment of the facility (e.g., lathes, lifts, crane, etc.). For example, the activities can include tasks performed by the worker, equipment worked with by the worker, time spent on a task or with a piece of equipment, or any other relevant information. In some cases, the activities can be used to log accidents that occur at the worksite. The activities can also include various performance metrics determined from the location and the time-logging information.

At 480, the cloud computing system 420 generates the experience profile of the worker based on the activity of the worker. The cloud computing system 420 automatically fills in information determined from the activity of the worker to build the experience profile of the worker. The data filled into the field space of the experience profile can include the specific number of hours that a worker has spent working with a particular type of equipment (e.g., 200 hours spent driving forklifts, 150 hours spent operating a lathe, etc.). The experience profile can further include various performance metrics associated with a particular task or piece of equipment. In embodiments, the cloud computing system 420 exports or publishes the experience profile to a user profile of a social or professional networking platform (e.g., such as LinkedIn™, Monster™, any other suitable social media or proprietary website, or a combination thereof). In embodiments, the cloud computing system 420 exports the experience profile in the form of a recommendation letter or reference package to past or prospective employers. The experience data enables a given worker to prove that they have a certain amount of experience with a given equipment platform.

### Example Facility

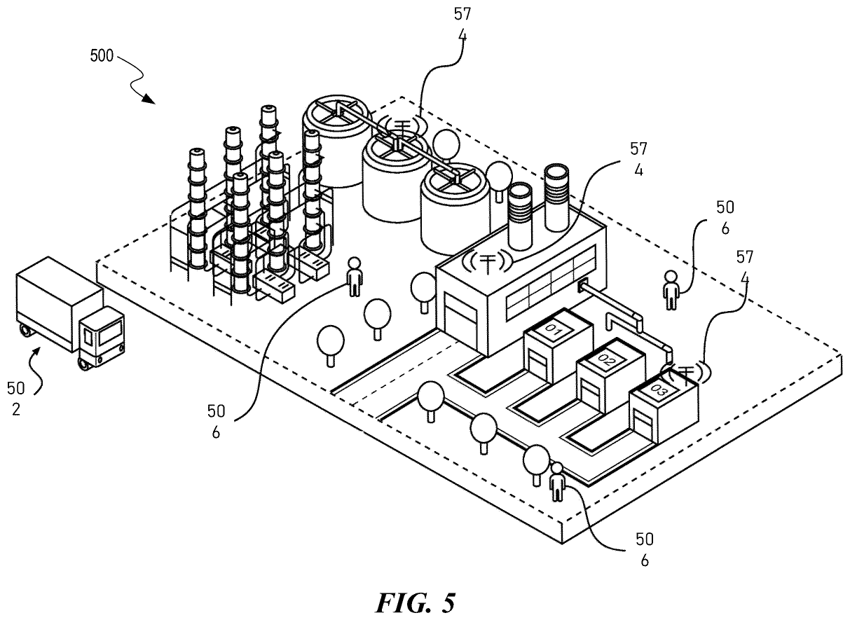

FIG. 5 is a drawing illustrating an example facility 500 of a worksite using apparatuses and communication networks for device communication and tracking, in accordance with one or more embodiments. For example, the facility 500 is a refinery, a manufacturing facility, a construction site, etc. The communication technology shown by FIG. 5 can be implemented using components of the example computer systems illustrated and described in more detail with reference to the other figures herein.

Multiple differently and strategically placed wireless antennas 574 are used to receive signals from an Internet source (e.g., a fiber backhaul at the facility), or a mobile system (e.g., a truck 502). The truck 502, in embodiments, can implement an edge kit used to connect to the Internet. The strategically placed wireless antennas 574 repeat the signals received and sent from the edge kit such that a private cellular network is made available to multiple workers 506. Each worker carries or wears a cellular-enabled smart radio, implemented in accordance with the embodiments described herein. A position of the smart radio is continually tracked during a work shift.

In implementations, a stationary, temporary, or permanently installed cellular (e.g., LTE or 5G) source is used that obtains network access through a fiber or cable backhaul. In embodiments, a satellite or other Internet source is embodied into hand-carried or other mobile systems (e.g., a bag, box, or other portable arrangement). FIG. 5 shows that multiple wireless antennas 574 are installed at various locations throughout the facility. Where the edge kit is located at a location near a facility fiber backhaul, the communication system in the facility 500 uses multiple omnidirectional Multi-Band Outdoor (MBO) antennas as shown. Where the Internet source is instead located near an edge of the facility 500, as is often the case, the communication system uses one or more directional wireless antennas to improve the coverage in terms of bandwidth. Alternatively, where the edge kit is in a mobile vehicle, for example, truck 502, the antennas' directional configuration would be picked depending on whether the vehicle would ultimately be located at a central or boundary location.

In embodiments where a backhaul arrangement is installed at the facility 500, the edge kit is directly connected to an existing fiber router, cable router, or any other source of Internet at the facility. In embodiments, the wireless antennas 574 are deployed at a location in which the smart radio is to be used. For example, the wireless antennas 574 are omnidirectional, directional, or semidirectional depending on the intended coverage area. In embodiments, the wireless antennas 574 support a local cellular network. In embodiments, the local network is a private LTE network (e.g., based on 4G or 5G). In more specific embodiments, the network is a CBRS Band 48 local network. The frequency range for CBRS Band 48 extends from 3550 MHz to 3700 MHz and is executed using TDD as the duplex mode. The private LTE wireless communication device is configured to operate in the private network created, for example, to accommodate CBRS Band 48 in the frequency range for Band 48 (again, from 3550 MHz to 3700 MHZ) and accommodates TDD. Thus, channels within the preferred range are used for different types of communications between the cloud and the local network.

### Geofencing

As described herein, smart radios are configured with location estimating capabilities and are used within a facility or worksite for which geofences are defined. A geofence refers to a virtual perimeter for a real-world geographic area, such as a portion of a facility or worksite. A smart radio includes location-aware devices that inform of the location of the smart radio at various times. Embodiments described herein relate to location-based features for smart radios or smart apparatuses. Location-based features described herein use location data for smart radios to provide improved functionality. In some embodiments, a location of a smart radio (e.g., a position estimate) is assumed to be representative of a location of a worker using or associated with the smart radio. As such, embodiments described herein apply location data for smart radios to perform various functions for workers of a facility or worksite.

Some example scenarios that require radio communication between workers are area-specific, or relevant to a given area of a facility. For example, when machines need repair, workers near the machine can be notified and provided instructions to assist in the repair. Alternatively, if a hazard is present at the facility, workers near the hazard can be notified.

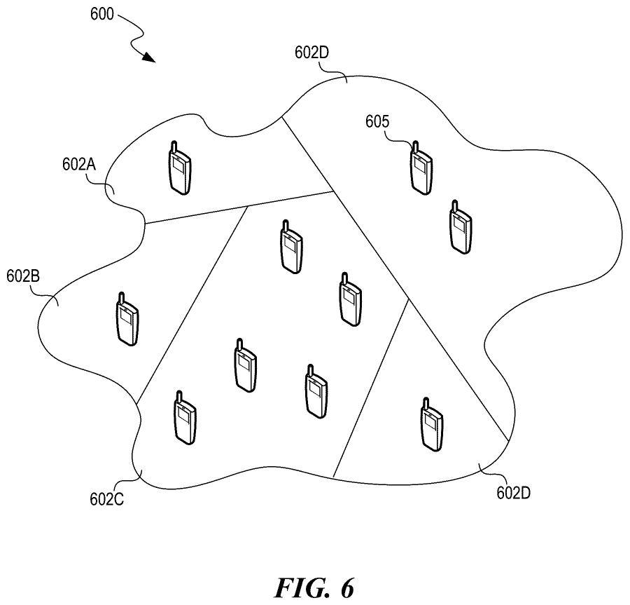

According to some embodiments, locations of smart radios are monitored such that at a point in time, each smart radio located in a specific geofenced area is identified. FIG. 6 illustrates an example of a worksite 600 that includes a plurality of geofenced areas 602, with smart radios 605 being located within the geofenced areas 602.

In some embodiments, an alert, notification, communication, and/or the like is transmitted to each smart radio 605 that is located within a geofenced area 602 (e.g., 602C) responsive to a selection or indication of the geofenced area 602. A smart radio 605, an administrator smart radio (e.g., a smart radio assigned to an administrator), or the cloud computing system is configured to enable user selection of one of the plurality of geofenced areas 602 (e.g., 602C). For example, a map display of the worksite 600 and the plurality of geofenced areas 602 is provided. With the user selection of a geofenced area 602 and a location for each smart radio 605, a set of smart radios 605 located within the geofenced area 602 is identified. An alert, notification, communication, and/or the like is then transmitted to the identified smart radios 605.

### ML System

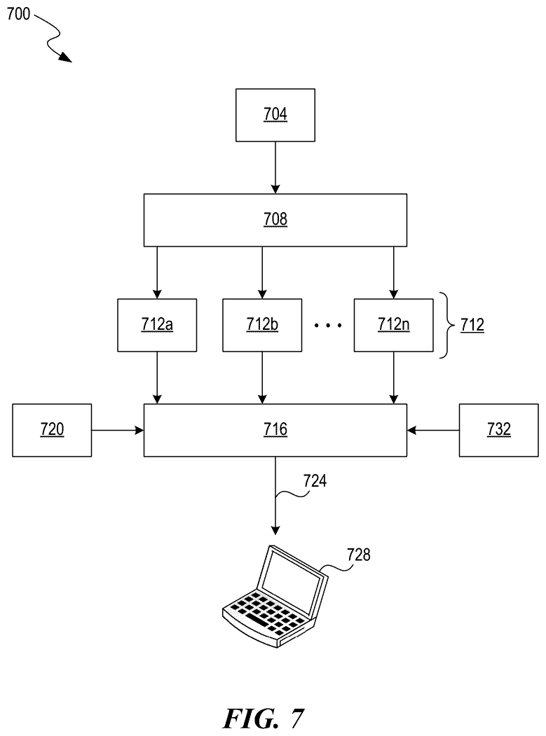

FIG. 7 is a block diagram illustrating an example ML system 700, in accordance with one or more embodiments. The ML system 700 can implement one or more components of the computer systems and apparatuses discussed herein. Although illustrated in a particular configuration, different embodiments of the ML system 700 include different and/or additional components and are connected in different ways. The ML system 700 is sometimes referred to as an ML module.

The ML system 700 includes a feature extraction module 708 implemented using components of an example computer system, as described herein. In some embodiments, the feature extraction module 708 extracts a feature vector 712 from input data 704. The feature vector 712 includes features 712a, 712b, . . . , 712n. The feature extraction module 708 reduces the redundancy in the input data 704, for example, repetitive data values, to transform the input data 704 into the reduced set of features 712, for example, features 712a, 712b, . . . , 712n. The feature vector 712 contains the relevant information from the input data 704, such that events or data value thresholds of interest are identified by the ML model 716 by using a reduced representation. In some example embodiments, the following dimensionality reduction techniques are used by the feature extraction module 708: independent component analysis, Isomap, principal component analysis (PCA), latent semantic analysis, partial least squares, kernel PCA, multifactor dimensionality reduction, nonlinear dimensionality reduction, multilinear PCA, multilinear subspace learning, semidefinite embedding, autoencoder, and deep feature synthesis.

In alternate embodiments, the ML model 716 performs deep learning (also known as deep structured learning or hierarchical learning) directly on the input data 704 to learn data representations, as opposed to using task-specific algorithms. In deep learning, no explicit feature extraction is performed; the features 712 are implicitly extracted by the ML system 700. For example, the ML model 716 uses a cascade of multiple layers of nonlinear processing units for implicit feature extraction and transformation. Each successive layer uses the output from the previous layer as input. The ML model 716 thus learns in supervised (e.g., classification) and/or unsupervised (e.g., pattern analysis) modes. The ML model 716 learns multiple levels of representations that correspond to different levels of abstraction, wherein the different levels form a hierarchy of concepts. The multiple levels of representation configure the ML model 716 to differentiate features of interest from background features.

In alternative example embodiments, the ML model 716, for example, in the form of a convolutional neural network (CNN), generates the output 724, without the need for feature extraction, directly from the input data 704. The output 724 is provided to the computer device 728. The computer device 728 is a server, computer, tablet, smartphone, smart speaker, etc., implemented using components of an example computer system, as described herein. In some embodiments, the steps performed by the ML system 700 are stored in memory on the computer device 728 for execution. In other embodiments, the output 724 is displayed on an apparatus or electronic displays of a cloud computing system.

A CNN is a type of feed-forward artificial neural network in which the connectivity pattern between its neurons is inspired by the organization of a visual cortex. Individual cortical neurons respond to stimuli in a restricted area of space known as the receptive field. The receptive fields of different neurons partially overlap such that they tile the visual field. The response of an individual neuron to stimuli within its receptive field is approximated mathematically by a convolution operation. CNNs are based on biological processes and are variations of multilayer perceptrons designed to use minimal amounts of preprocessing.

In embodiments, the ML model 716 is a CNN that includes both convolutional layers and max pooling layers. For example, the architecture of the ML model 716 is “fully convolutional,” which means that variable sized sensor data vectors are fed into it. For convolutional layers, the ML model 716 specifies a kernel size, a stride of the convolution, and an amount of zero padding applied to the input of that layer. For the pooling layers, the ML model 716 specifies the kernel size and stride of the pooling.

In some embodiments, the ML system 700 trains the ML model 716, based on the training data 720, to correlate the feature vector 712 to expected outputs in the training data 720. As part of the training of the ML model 716, the ML system 700 forms a training set of features and training labels by identifying a positive training set of features that have been determined to have a desired property in question, and, in some embodiments, forms a negative training set of features that lack the property in question.

The ML system 700 applies ML techniques to train the ML model 716, such that when applied to the feature vector 712, output indications of whether the feature vector 712 has an associated desired property or properties, such as a probability that the feature vector 712 has a particular Boolean property, or an estimated value of a scalar property. In embodiments, the ML system 700 further applies dimensionality reduction (e.g., via linear discriminant analysis (LDA), PCA, or the like) to reduce the amount of data in the feature vector 712 to a smaller, more representative set of data.

In embodiments, the ML system 700 uses supervised ML to train the ML model 716, with feature vectors of the positive training set and the negative training set serving as the inputs. In some embodiments, different ML techniques, such as linear support vector machine (linear SVM), boosting for other algorithms (e.g., AdaBoost), logistic regression, naïve Bayes, memory-based learning, random forests, bagged trees, decision trees, boosted trees, boosted stumps, neural networks, CNNs, etc., are used. In some example embodiments, a validation set 732 is formed of additional features, other than those in the training data 720, which have already been determined to have or to lack the property in question. The ML system 700 applies the trained ML model 716 to the features of the validation set 732 to quantify the accuracy of the ML model 716. Common metrics applied in accuracy measurement include Precision and Recall, where Precision refers to a number of results the ML model 716 correctly predicted out of the total it predicted, and Recall is a number of results the ML model 716 correctly predicted out of the total number of features that had the desired property in question. In some embodiments, the ML system 700 iteratively retrains the ML model 716 until the occurrence of a stopping condition, such as the accuracy measurement indication that the ML model 716 is sufficiently accurate, or a number of training rounds having taken place. In embodiments, the validation set 732 includes data corresponding to confirmed locations, dates, times, activities, or combinations thereof. This allows the detected values to be validated using the validation set 732. The validation set 732 is generated based on the analysis to be performed.

### Dynamic Worksite Directory for Geofenced Area

Embodiments include a system that implements the disclosed technology to generate a worksite-specific directory that merges data of one or more subordinate team-specific directories of respective companies, where all the directories are hosted on one or more common platforms but are maintained as separate and distinct directories (e.g., private directories). The worksite-specific directory contains a vector of features (“feature vector”) for each individual; for example, personnel information for the individual is stored as a feature vector where features including Identifier, Name, Level, Role, Location, Teams, and/or Responsibility Level. Each feature in the vector of features is a dimension along which the worksite-specific directory can be indexed. A user or a system may use the feature vector to select, for example, all users in the worksite-specific directory with Responsibility Level 3 and above and whose locations are within an area. In this regard, the worksite-specific directory can resemble a relational database (e.g., an SQL database). In some embodiments, the worksite-specific directory can resemble a non-relational database. The worksite-specific directory can update an entry when it receives notification that one or more features of said entry are modified. For example, if Sally Smith's Responsibility Level increases due to a promotion, the worksite-specific directory can accordingly adjust the entry under the feature Responsibility Level to 5 instead of 4. Additionally, the Location feature may, in some embodiments, be a real-time location received through communication with a smart radio of an associated user.

The system can receive a request to establish a team-specific directory that is synchronized with other directories or that synchronizes the other directories to create a worksite-specific directory. The request can specify multiple descriptive feature vectors. The system can index the worksite-specific directory by role and team to find one or more entries satisfying the requirements of the request. The system can generate a link to an entry in a team-specific directory and add it to the worksite-specific directory. If the entry in the team-specific directory for Sally Smith later changes such that it no longer represents a construction chief on a worksite (e.g., Sally Smith has transferred onto a different team and is not at the Construction One), the system can dynamically update the link for the worksite-specific directory.

For example, in response to detecting a change in the entry for Sally Smith, the system can initiate an update for a replacement construction chief at the worksite. The system can index the worksite-specific directory by role and team once more and find that Michael Mann is the new construction chief at the worksite. Therefore, the system can update the link for the worksite-specific directory to refer to Michael Mann. In some embodiments, the links added to team-specific directories resemble the data structure of a pointer. The system can dynamically adjust entries of the worksite-specific directory to which links point based on the real-time location of smart radios. For example, Sally Smith, being a construction chief on the Construction One team at a worksite, can be selected for the worksite-specific directory when Michael Mann, the other construction chief on the Construction One team, has a location outside of a geofence of the worksite.

Hence, the worksite-specific directory can integrate feature vectors representing workers from different team-specific directories of respective organizations. Doing so allows a customer to integrate the services of multiple distinct teams and manage communications through a single directory rather than needing to manage separate contacts for different workers from different teams that work on the same project. For example, a homeowner may undergo a renovation project at his house. To that end, he may hire a team of plumbers and a team of electricians. In order to manage workers from the plumber team and the electrician team, all of whose contact information he does not have, the homeowner can establish a worksite-specific directory to display worker information on his property on any given day. Thus, with permission, the homeowner can add the members of the plumber team and the members of the electrician team to his worksite-specific directory. This worksite-specific directory grants him access to, e.g., the contact information of team members and descriptions of their roles and responsibilities. The worksite-specific directory can be populated from respective team-specific directories of the plumbing team and the electrical team. The specific team-specific directories are not otherwise available for viewing outside their respective teams. That is, only the homeowner can view the information, while the plumbing team may not have visibility into the directory of the electrician team, or vice versa.

In some embodiments, subordinate team-specific directories impose restrictions or requirements on the links to feature vectors available to the worksite-specific directory to limit the information that is available for viewing. To use the above example, the plumbing team and the electrician team both have large numbers of workers, who work on different projects at different worksites. Therefore, the homeowner only needs access to data of workers who are currently on his worksite at any point in time, and having a large number of irrelevant feature vectors in the worksite-specific directory is onerous and makes contacting the right person difficult. To limit the worksite-specific directory to only the workers whom the homeowner needs to contact, the worksite-specific directory sets a geofence requirement for feature vectors. As such, the worksite-specific directory only enables links to feature vectors of users having smart radios with real-time locations that are within a preset bound—for example, the perimeter of the renovation project. If the perimeter is enclosed within certain GPS locations, then any links to data about workers on the plumber or electrician teams outside these bounds are removed from the worksite-specific directory, to be added when they reenter the geofence area. As such, a worker on their off day might be in a location outside the geofenced area and may, therefore, be delisted from the worksite-specific directory. Thus, the worksite-specific directory only lists the workers who are presently on-site.

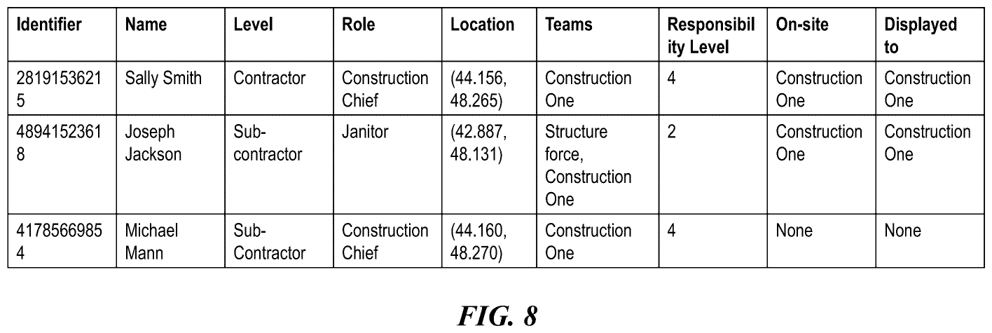

FIG. 8 shows an example of a worksite-specific directory that dynamically merges data from one or more subordinate team-specific directories. The worksite-specific directory contains feature vectors, in this case, Identifier, Name, Level, Role, Location, Teams, and/or Responsibility Level. Such information may be gathered when a smart radio is assigned to a user and the user inputs data about themselves. In some embodiments, metadata is updated when the system receives notifications from one or more servers that store data of the above features. For example, the system can access a human resources database of a team's organization and automatically update for staffing changes. When a user is added to or removed from a team, the platform can update the worksite-specific directory; similarly, changes to role descriptions or responsibility levels can be dynamically updated.

In some embodiments, the worksite-specific directory has a structure similar to a relational database, where the identifier of each entry in the worksite-specific directory acts as the common identifier across team-specific directories of different companies. The worksite-specific directory can be indexable using one or more features. For example, a server or system can filter the entries of the worksite-specific directory to show only the entries with Responsibility Level 4 and above or the entries with the level of “contractor.” Multiple filters can be joined to form a query, and the worksite-specific directory, when filtered, may return a set of entries. Each entry corresponds to a feature vector, representing, e.g., a worker on a team responsible for a specific job at a worksite.

The system creates links to point to entries in directories. For example, a link can be added between a team-specific directory and a worksite-specific directory. The link can enable a line of communication such that the worksite-specific directory can copy a feature vector from a team-specific directory. The worksite-specific directory can also modify the entry to which a link points, and the team-specific directory can correspondingly display the updated feature vector supplied by the worksite-specific directory. This allows for the instantaneous and consistent updating of data across directories.

In some embodiments, the worksite-specific directory can store a flag for each feature vector to indicate that an associated worker is currently at a worksite. The perimeter of a worksite defines a geofence that is used to identify feature vectors of workers who should be included in the worksite-specific directory from the team-specific directories. As such, a flag can change to indicate a status of whether a worker is located at or outside a worksite. For example, a flag can be added to the feature vector for Sally Smith to indicate that she is on-site at the worksite, where the flag links the feature vector data of a team-specific directory including the feature vector for Sally Smith to the worksite-specific directory. In contrast, a flag associated with the feature vector for Michael Mann is removed to indicate when he is not at the worksite.

A worker associated with a smart radio has data stored on the team-specific directory and may need to give consent to have the data added to a worksite-specific directory. For example, a user interface can be presented on a smart radio for a user receiving a request to be added to a worksite-specific directory. As such, an organization with an interest in establishing a worksite-specific directory containing information of workers from different teams can send requests to smart radios associated with the workers. In some embodiments, workers can send similar requests to other workers or to systems representing organizations in order to establish a worksite-specific directory.

From a user's perspective, for example, a request is made to be added to a worksite-specific directory in a conversational context on a smart radio. An interactable control presented on the user interface allows the user to respond, either accepting or declining the request. Separately, the user can receive a request to add subordinates to a worksite-specific directory. In an example, John Johnson is a subordinate of the user to whom the original request is directed. Thus, the user can choose whether to accept adding a feature vector corresponding to John Johnson to the worksite-specific directory.

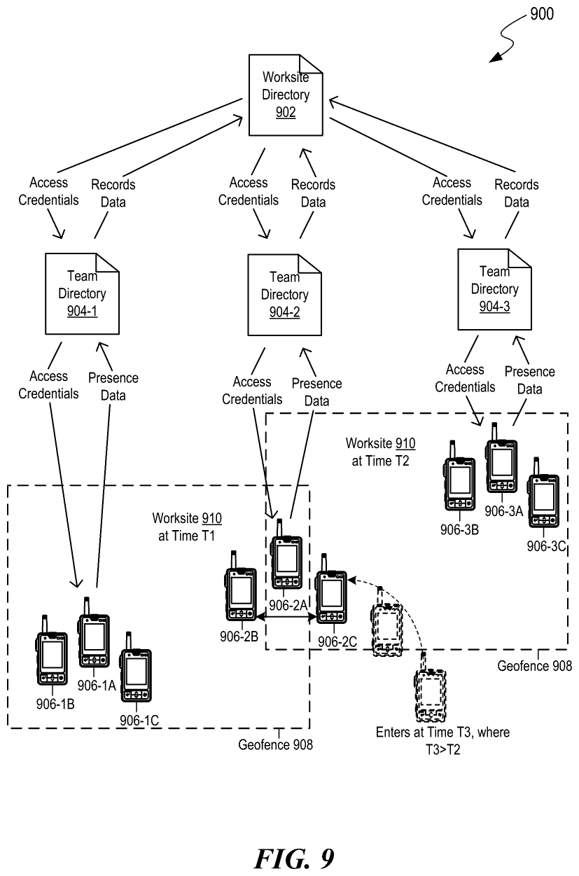

FIG. 9 is a block diagram 900 that illustrates a worksite directory 902 that dynamically harmonizes different team directories 904-1, 904-2, and 904-3 (also referred to collectively herein as “team directories 904”) in a geofenced worksite. The worksite directory 902 is a primary directory including records of users of smart radios currently in the worksite area having boundaries defined by a geofence. As such, the worksite directory 902 includes records for frontline workers in the geofenced area and dynamically changes to add (or unhides) records for users of the smart radios that enter the worksite and remove (or hide) records for users of smart radios that leave the worksite. As such, the worksite directory 902 changes as smart radios enter and leave the worksite.

The worksite directory 902 is populated with record data from team directories 904 of team members using smart radios that are in the geofenced worksite. The records data is provided from the team directories 904 to the worksite directory 902 in accordance with access credentials. In particular, the worksite directory 902 provides access credentials for the records data of a team directory. The access credentials are part of access controls that allow or deny access to data records of particular users of particular smart radios in the geofenced area. The access controls enable providing all data records for a team directory or only part of the data records. For example, the team directory 904-1 can include multiple data records for multiple users, but only some are assigned to work in the geofenced worksite. As such, the access controls can limit access to records data of only those workers who are assigned to, affiliated with, and/or present at the worksite.

The team directories 904-1, 904-2, and 904-3 are different subordinate directories to the worksite directory. The worksite directory has access credentials for each of the team directories 904-1, 904-2, and 904-3. The access credentials can be the same or different for each of the team directories 904-1, 904-2, and 904-3. The data records from the team directories 904 are added dynamically to the worksite directory 902, which can be configured to remove records data for workers who are no longer in the geofenced worksite. In one example, the records data can include the feature vector data of workers who belong to a team and are assigned to work on the worksite. The team directories 904 can also send flags indicative of the presence of the workers, which can be used by the worksite directory to hide or unhide records depending on whether the smart radios of the workers are in the geofenced worksite or not.

The team directories 904 can themselves have access credentials required to receive presence data of the smart radios 906-1A through 906-3B. As shown, the team directory 904-1 includes record data for users associated with the smart radios 906-1A through 906-1C. The presence of the smart radios 906-1A through 906-1C in the geofence 908 of the worksite 910 is monitored and communicated to enable the team directory 904-1 to provide the corresponding records data to the worksite directory 902. Likewise, the team directory 904-2 includes record data for users associated with the smart radios 906-2A through 906-2C. The presence of the smart radios 906-2A through 906-2C in the geofence 908 of the worksite 910 is monitored and communicated to enable the team directory 904-2 to provide the corresponding records data to the worksite directory 902. Further, the team directory 904-3 includes record data for users associated with the smart radios 906-3A through 906-3C. The presence of the smart radios 906-3A through 906-3C in the geofence 908 of the worksite 910 is monitored and communicated to enable the team directory 904-3 to provide the corresponding records data to the worksite directory 902. Although shown as being supplied to a respective team directory, presence data can be provided directly to the worksite directory to hide or unhide records depending on whether the smart radios are within or outside of the geofence 908 of the worksite 910, respectively.

In the illustrated example, the records data of the team directory 904-1 and part of team directory 904-2 are provided to the worksite directory 902 at time T1. In particular, each of the smart radios 906-1A, 906-1B, 906-1C, 906-2A, and 906-2B are at least partially within the geofence 908 of the worksite 910 at time T1. As such, the worksite directory shows the corresponding records data for the users of the smart radios 906-1A, 906-1B, 906-1C, 906-2A, and 906-2B. At time T1, the data record for the user of the smart radio 906-2C is not available at the worksite directory 902 because the smart radio 906-2C is not within the geofence 908 of the worksite 910.

At time T2, each of the smart radios 906-2A, 906-3A, 906-3B, and 906-3C are at least partially within the geofence 908 of the worksite 910 and the smart radios 906-1A, 906-1B, 906-1C, and 906-2B are outside of the geofence 908. As such, only the records data for the smart radio devices within the geofence 908 are incorporated into the worksite directory 902. At time T3, which is after time T2, the smart radio 906-2C enters the geofence 908 of the worksite 910. In response, the corresponding record data for the user of the smart radio 906-2C becomes available at the worksite directory 902. The data record for the user of the smart radio 906-2C has a role equivalent to the user of the smart radio 902-2B (e.g., a “supervisor” role) such that the worksite directory 902 is updated to reflect that there is a different user having the same role at time T3, after time T1. As such, the worksite directory 902 dynamically updates with records data of users associated with smart radios that move in and out of the geofence 908 of the worksite 910.

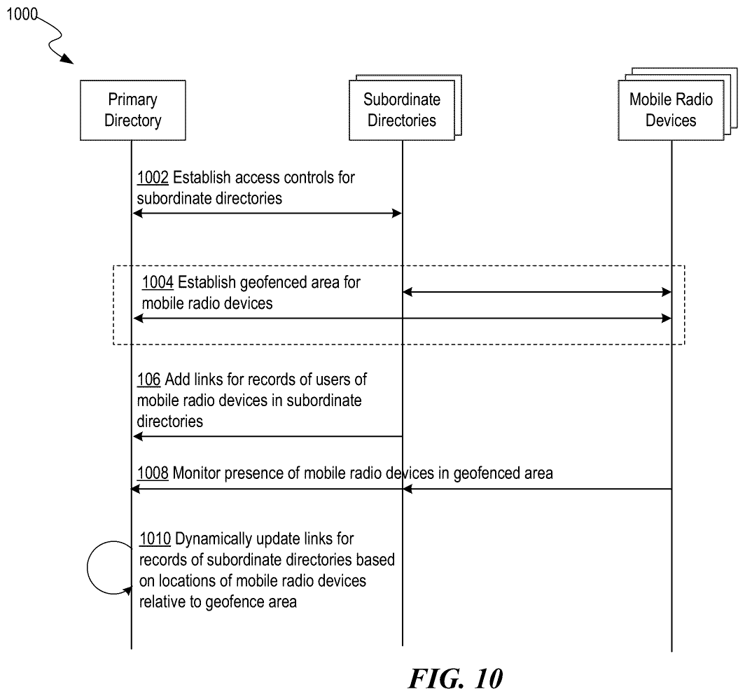

FIG. 10 is a flow diagram that illustrates processes 1000 for dynamically updating a worksite-specific directory to harmonize team-specific directories. The processes 1000 can be performed by a system including one or more servers hosting a platform that administers different directories and mobile radio devices (e.g., smart radios). In one example, components of the system include at least one hardware processor and at least one non-transitory memory storing instructions, which, when executed by the at least one hardware processor, cause the system to perform the processes 1000.

At 1002, the system establishes access controls for the worksite-specific directory to access the multiple team-specific directories. The multiple team-specific directories include feature vector data administered by the platform that hosts smart radio devices allocated to teams for respective team-specific directories. Further, the multiple team-specific directories are separate and independent of each other and are subordinate to the worksite-specific directory (e.g., a primary directory). In one example, the system sets first access controls for a first team-specific directory and sets second access controls for a second team-specific directory. The first access controls grant access to a first set of feature vector data of a first set of users of smart radio devices assigned to the worksite, and the second access controls grant access to a second set of feature vector data of a second set of users of smart radio devices assigned to the worksite. The second access controls are independent of the first access controls.

At 1004, the system instantiates a geofence that defines a boundary of a geographic area for a worksite of the worksite-specific directory. The worksite-specific directory is configured to display records including feature vector data for users of the smart radio devices that are located within the geographic area of the worksite. For example, each feature vector data of each user of a respective smart radio device comprises a combination of an identifier of the user, an identifier of the smart radio device, a supervisory level of the user, a role of the user for the worksite, a location of the smart radio device, a team to which the user belongs, and/or a responsibility level of the user for a job at the worksite.

At 1006, the system adds, at the worksite-specific directory, links for feature vector data in the multiple team-specific directories based on the access controls. The links grant access to feature vector data of the multiple team-specific directories. In one example, the system modifies the worksite-specific directory to include links to feature vector data in the multiple team-specific directories. As such, the worksite-specific directory is configured to use the links to access feature vector data stored at the multiple team-specific directories. In another example, the system copies feature vector data from the multiple team-specific directories to the worksite-specific directory and associates feature vector data copied at the worksite-specific directory with different levels of access permissions. For example, a first level of the access permissions can grant access to a portion of particular feature vector data, and a second level of the access permission grants access to more than the portion of the particular feature vector data.

At 1008, the system monitors (e.g., tracks) locations of the users relative to the geofence of the geographic area for the worksite based on locations of their smart radio devices. In one example, for each smart radio device, the system receives an indication and a geographic location of the smart radio device, compares the geographic location of the smart radio device to the geographic area of the worksite, and determines whether the smart radio device is within or outside of the geographic area of the worksite. In another example, for each smart radio device, the system receives regular periodic signals generated by the smart radio device. The periodic signals can indicate locations of the smart radio device at different points in time. The system determines whether the smart radio device is within the geographic area of the worksite for at least a first threshold period of time and/or whether the smart radio device is outside of the geographic area of the worksite for at least a second threshold period of time.

At 1010, the system dynamically updates, at the worksite-specific directory, the links for feature vector data of the multiple team-specific directories based on the locations of the users relative to the geofence of the geographic area for the worksite. In particular, the system enables links, at the worksite-specific directory, for feature vector data of users determined to be at least partially within the geographic area and disables links for feature vector data of users determined to be outside the geographic area. In one example, the system adds links to the worksite-specific directory for users determined to be at least partially within the geographic area and removes links from the worksite-specific directory for users determined to be outside of the geographic area. In another example, the system enables links at the worksite-specific directory for feature value data of users determined to be inside of the geographic area and disables links for feature value data of users determined to be outside of the geographic area. More generally, the system can provide access to records of users of mobile radio devices of a first subordinate directory and of a second subordinate directory determined to be within the geographic area and prohibit access to records of users of mobile radio devices of the first subordinate directory and of the second subordinate directory determined to be outside of the geographic area.

As such, the system can harmonize at least two subordinate directories at a primary directory by assigning sets of users of mobile radio devices to the geographic area, where each set belongs to a respective group of users with records stored at the subordinate directories. The system can authorize the primary directory to access records of users maintained at the subordinate directories.

In one example, a computer system (e.g., administrative device) or a mobile radio device can access the worksite-specific directory that is dynamically updated based on whether mobile radio devices are within or outside of a geographic area. For example, the mobile radio device can present, on a display device, the primary directory including records for users of mobile radio devices that are located within the geographic area. The mobile radio device can receive an input including a query configured to cause the mobile radio device to search the primary directory for a record of a particular user having a particular type of role. In response, the mobile radio device is caused to display, on the display device, a search result including a particular record from a particular subordinate directory of the multiple subordinate directories. The particular record is for a particular user having the particular type of role and being present in the geographic area. The subordinate directory includes multiple records for users having the particular type of role that would satisfy the query.

The mobile radio device can dynamically update the primary directory to include a current record in the subordinate directory for a current user having the role of the particular type and having a current location within the geographic area. The mobile radio device can disable any links to the multiple subordinate directories for records of users of mobile radio devices being outside of the geographic area and enable any links to the multiple subordinate directories for records of users of mobile radio devices being within the geographic area.

Industrial equipment is a significant contributor to the generation of greenhouse gas emissions. The disclosed smart radios improve efficiency to repair potentially environmentally hazardous conditions on industrial equipment. The improvements in efficiency come from both addressing the issues more quickly and from reducing the amount of driving (e.g., using internal combustion engines) around worksites that may be many square miles large. First, as noted earlier, malfunctioning industrial equipment can be a significant contributor to the generation of greenhouse gas emissions-improving the rate at which these hazardous conditions are repaired reduces the amount of harmful gas (e.g., greenhouse gas) that is released into the environment. Second, by making use of local workers rather than dispatched workers, additional transport trips, which generate additional emissions, become unnecessary. As such, the disclosed technology reduces and/or prevents greenhouse gas emissions.

### Computing System

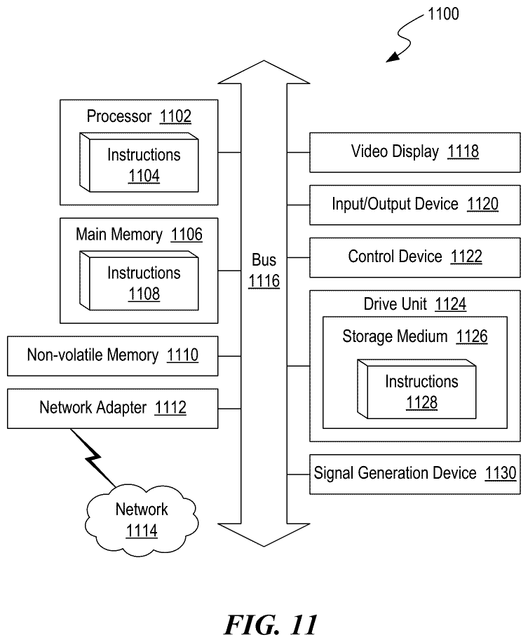

FIG. 11 is a block diagram illustrating an example computer system 1100, in accordance with one or more embodiments. At least some operations described herein are implemented on the computer system 1100. The computer system 1100 includes one or more central processing units (“processors”) 1102, main memory 1106, non-volatile memory 1110, network adapters 1112 (e.g., network interface), video displays 1118, input/output devices 1120, control devices 1122 (e.g., keyboard and pointing devices), drive units 1124 including a storage medium 1126, and a signal generation device 1130 that are communicatively connected to a bus 1116. The bus 1116 is illustrated as an abstraction that represents one or more physical buses and/or point-to-point connections that are connected by appropriate bridges, adapters, or controllers. In embodiments, the bus 1116 includes a system bus, a Peripheral Component Interconnect (PCI) bus or PCI-Express bus, a HyperTransport or industry standard architecture (ISA) bus, a small computer system interface (SCSI) bus, a universal serial bus (USB), an IIC (I2C) bus, or an IEEE standard 1394 bus (also referred to as “Firewire”).

In embodiments, the computer system 1100 shares a similar computer processor architecture as that of a desktop computer, tablet computer, personal digital assistant (PDA), mobile phone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the computer system 1100.

While the main memory 1106, non-volatile memory 1110, and storage medium 1126 (also called a “machine-readable medium”) are shown to be a single medium, the terms “machine-readable medium” and “storage medium” should be taken to include a single medium or multiple media (e.g., a centralized/distributed database and/or associated caches and servers) that store one or more sets of instructions 1128. The terms “machine-readable medium” and “storage medium” shall also be taken to include any medium that is capable of storing, encoding, or carrying a set of instructions for execution by the computer system 1100.

In general, the routines executed to implement the embodiments of the disclosure are implemented as part of an operating system or a specific application, component, program, object, module, or sequence of instructions (collectively referred to as “computer programs”). The computer programs typically include one or more instructions (e.g., instructions 1104, 1108, 1128) set at various times in various memory and storage devices in a computer device. When read and executed by the one or more processors 1102, the instruction(s) cause the computer system 1100 to perform operations to execute elements involving the various aspects of the disclosure.

Moreover, while embodiments have been described in the context of fully functioning computer devices, those skilled in the art will appreciate that the various embodiments are capable of being distributed as a program product in a variety of forms. The disclosure applies regardless of the particular type of machine or computer-readable media used to actually effect the distribution.

Further examples of machine-readable storage media, machine-readable media, or computer-readable media include recordable-type media such as volatile and non-volatile memory devices 1110, floppy and other removable disks, hard disk drives, optical discs (e.g., Compact Disc Read-Only Memory (CD-ROMS), Digital Versatile Discs (DVDs)), and transmission-type media such as digital and analog communication links.

The network adapter 1112 enables the computer system 1100 to mediate data in a network 1114 with an entity that is external to the computer system 1100 through any communication protocol supported by the computer system 1100 and the external entity. In embodiments, the network adapter 1112 includes a network adapter card, a wireless network interface card, a router, an access point, a wireless router, a switch, a multilayer switch, a protocol converter, a gateway, a bridge, a bridge router, a hub, a digital media receiver, and/or a repeater.

In embodiments, the network adapter 1112 includes a firewall that governs and/or manages permission to access proxy data in a computer network and tracks varying levels of trust between different machines and/or applications. In embodiments, the firewall is any number of modules having any combination of hardware and/or software components able to enforce a predetermined set of access rights between a particular set of machines and applications, machines and machines, and/or applications and applications (e.g., to regulate the flow of traffic and resource sharing between these entities). The firewall additionally manages and/or has access to an access control list that details permissions including the access and operation rights of an object by an individual, a machine, and/or an application, and the circumstances under which the permission rights stand.

In embodiments, the functions performed in the processes and methods are implemented in differing order. Furthermore, the outlined steps and operations are only provided as examples. For example, some of the steps and operations are optional, combined into fewer steps and operations, or expanded into additional steps and operations without detracting from the essence of the disclosed embodiments.

In embodiments, the techniques introduced here are implemented by programmable circuitry (e.g., one or more microprocessors), software and/or firmware, special-purpose hardwired (i.e., non-programmable) circuitry, or a combination of such forms. In embodiments, special-purpose circuitry is in the form of one or more application-specific integrated circuits (ASICs), programmable logic devices (PLDs), field-programmable gate arrays (FPGAs), etc.

The description and drawings herein are illustrative and are not to be construed as limiting. Numerous specific details are described to provide a thorough understanding of the disclosure. However, in certain instances, well-known details are not described in order to avoid obscuring the description. Further, various modifications can be made without deviating from the scope of the embodiments.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. It will be appreciated that the same thing can be said in more than one way. One will recognize that “memory” is one form of a “storage” and that the terms are on occasion used interchangeably.

Consequently, alternative language and synonyms are used for any one or more of the terms discussed herein, and no special significance is to be placed upon whether or not a term is elaborated or discussed herein. Synonyms for certain terms are provided. A recital of one or more synonyms does not exclude the use of other synonyms. The use of examples anywhere in this specification, including examples of any term discussed herein, is illustrative only and is not intended to further limit the scope and meaning of the disclosure or of any exemplified term. Likewise, the disclosure is not limited to various embodiments given in this specification.

1. A method for dynamically updating a worksite-specific directory with feature vector data of users from multiple team-specific directories, the method comprising:
establishing access controls for the worksite-specific directory to access the multiple team-specific directories,
wherein the multiple team-specific directories include feature vector data administered by a platform that hosts smart radio devices allocated to teams for respective team-specific directories, and
wherein the multiple team-specific directories are separate and independent of each other and are subordinate to the worksite-specific directory;
instantiating a geofence that defines a boundary of a geographic area for a worksite of the worksite-specific directory,
wherein the worksite-specific directory is configured to display feature vector data for users of the smart radio devices that are located within the geographic area of the worksite;
adding, at the worksite-specific directory, links for feature vector data in the multiple team-specific directories based on the access controls, the links granting access to feature vector data of the multiple team-specific directories;
tracking locations of the users relative to the geofence of the geographic area for the worksite based on locations of the smart radio devices; and
dynamically updating, at the worksite-specific directory, the links for feature vector data of the multiple team-specific directories based on the locations of the users relative to the geofence of the geographic area for the worksite,
wherein links, at the worksite-specific directory, for feature vector data of users determined to be inside the geographic area are enabled, and
wherein links, at the worksite-specific directory, for feature vector data of users determined to be outside the geographic area are disabled.

2. The method of claim 1, wherein establishing access controls for the worksite-specific directory to access the multiple team-specific directories comprises:
setting first access controls for a first team-specific directory, the first access controls granting access to a first set of feature vector data of a first set of users of smart radio devices assigned to the worksite; and
setting second access controls for a second team-specific directory, the second access controls granting access to a second set of feature vector data of a second set of users of smart radio devices assigned to the worksite,
wherein the second access controls are independent of the first access controls.

3. The method of claim 2, wherein each feature vector data of each user of respective smart radio devices comprises a combination of:
an identifier of the user,
an identifier of the smart radio device,
a supervisory level of the user,
a role of the user for the worksite,
a location of the smart radio device,
a team to which the user belongs, or
a responsibility level of the user for a job at the worksite.

4. The method of claim 1, wherein adding links, at the worksite-specific directory, for feature vector data comprises:
modifying the worksite-specific directory to include links to feature vector data in the multiple team-specific directories,
wherein the worksite-specific directory is configured to use the links to access feature vector data stored at the multiple team-specific directories.

5. The method of claim 1, wherein adding links, at the worksite-specific directory, for feature vector data comprises:
copying feature vector data from the multiple team-specific directories to the worksite-specific directory; and
associating feature vector data copied at the worksite-specific directory with different levels of access permissions,
wherein a first level of the access permissions grants access to a portion of particular feature vector data, and
wherein a second level of the access permission grants access to more than the portion of the particular feature vector data.

6. The method of claim 1, wherein tracking locations of the users relative to the geofence of the worksite based on locations of the smart radio devices comprises, for each smart radio device:
receiving an indication and a geographic location of the smart radio device;
comparing the geographic location of the smart radio device to the geographic area of the worksite; and
determining whether the smart radio device is within or outside of the geographic area of the worksite.

7. The method of claim 1, wherein tracking locations of the users relative to the geofence of the worksite based on locations of the smart radio devices comprises, for each smart radio device:
receiving periodic signals generated by the smart radio device,
wherein the periodic signals indicate locations of the smart radio device at different points in time;
determining whether the smart radio device is within the geographic area of the worksite for at least a first threshold period of time; and
determining whether the smart radio device is outside of the geographic area of the worksite for at least a second threshold period of time.

8. The method of claim 1, wherein dynamically updating links, on the worksite-specific directory, for the multiple team-specific directories comprises:
adding links to the worksite-specific directory for users determined to be inside of the geographic area; and
removing links from the worksite-specific directory for users determined to be outside of the geographic area.

9. The method of claim 1, wherein dynamically updating links, on the worksite-specific directory, for the multiple team-specific directories comprises:
enabling links at the worksite-specific directory for feature value data of users determined to be inside of the geographic area; and
disabling links at the worksite-specific directory for feature value data of users determined to be outside of the geographic area.

10. A non-transitory, computer-readable storage medium comprising instructions recorded thereon, wherein the instructions, when executed by at least one data processor of a system, cause the system to:
instantiate a primary directory configured to provide a record for each user of a mobile radio device that is located within a geographic area;
monitor the geographic area for presence of one or more mobile radio devices,
wherein the geographic area has a boundary defined by a geofence detectable by each of the one or more mobile radio devices;
harmonize at least two subordinate directories at the primary directory,
wherein a first subordinate directory is configured to manage records for users of a first set of mobile radio devices,
wherein a second subordinate directory is configured to manage records for users of a second set of mobile radio devices, and
wherein the second subordinate directory is administered independently of the second subordinate directory; and
dynamically update the primary directory to:
provide access to records of users of mobile radio devices of the first subordinate directory and of the second subordinate directory determined to be within the geographic area; and
prohibit access to records of users of mobile radio devices of the first subordinate directory and of the second subordinate directory determined to be outside of the geographic area.

11. The non-transitory, computer-readable storage medium of claim 10, wherein to harmonize the at least two subordinate directories at the primary directory comprises causing the system to:
assign a first set of users of a first set of mobile radio devices to the geographic area, the first set of mobile radio devices belonging to a first group of users with records stored at the first subordinate directory;
assign a second set of users of a second set of mobile radio devices to the geographic area, the second set of mobile radio devices belonging to a second group of users with records stored at the second subordinate directory; and
authorize the primary directory to access records of the first set of users maintained by the first subordinate directory and the second set of users maintained by the second subordinate directory.

12. The non-transitory, computer-readable storage medium of claim 10, wherein to harmonize the at least two subordinate directories at the primary directory comprises causing the system to:
modify the primary directory to include links to the records in the at least two subordinate directories,
wherein the primary directory is configured to index the links for accessing the records of the at least two subordinate directories.

13. The non-transitory, computer-readable storage medium of claim 10, wherein to harmonize the at least two subordinate directories at the primary directory comprises causing the system to:
copy records in the at least two subordinate directories to the primary directory; and
link the records copied to the primary directory to different levels of access permissions,
wherein each level of access permissions allows access to varying amounts of the records.

14. The non-transitory, computer-readable storage medium of claim 10, wherein the system is caused to:
receive indications of locations of the mobile radio devices; and
determine whether the locations of the mobile radio devices are within or outside of the geographic area.

15. The non-transitory, computer-readable storage medium of claim 10, wherein the system is caused to:
receive periodic signals generated by the mobile radio devices,
wherein the periodic signals indicate locations of the mobile radio devices at different points in time; and
determine whether any of the mobile radio devices are within or outside of the geographic area for a threshold time period.

16. The non-transitory, computer-readable storage medium of claim 10, wherein to dynamically update the primary directory comprises causing the system to:
add links to the primary directory for records of users determined to be inside of the geographic area; and
remove links from the primary directory for records of users determined to be outside of the geographic area.

17. The non-transitory, computer-readable storage medium of claim 10, wherein to dynamically update the primary directory comprises causing the system to:
enable existing links in the primary directory for records of users determined to be inside of the geographic area; and
disable existing links in the primary directory for records of users determined to be outside of the geographic area.

18. A mobile radio device comprising:
a display device;
at least one hardware processor; and
at least one non-transitory memory storing instructions, which, when executed by the at least one hardware processor, cause the mobile radio device to:
cause the display device to present a primary directory including records for users of mobile radio devices that are located within a geographic area;
wherein the primary directory harmonizes records of multiple subordinate directories with users assigned to the geographic area for the primary directory, and
wherein the multiple subordinate directories are independent of each other and include respective groups of mobile radio devices;
receive a first input including a query configured to cause the mobile radio device to search the primary directory for a record of a particular user having a particular type of role; and
in response to the first input, cause the mobile radio device to display, on the display device, a search result including a particular record from a particular subordinate directory of the multiple subordinate directories, the particular record being for a particular user having the particular type of role and being present in the geographic area,
wherein the subordinate directory includes multiple records for users having the particular type of role that would satisfy the query.

19. The mobile radio device of claim 18 further caused to:
dynamically update the primary directory to include a current record in the subordinate directory for a current user having the role of the particular type and having a current location within the geographic area.

20. The mobile radio device of claim 18 further caused to:
disable any links to the multiple subordinate directories for records of users of mobile radio devices being outside of the geographic area; and
enable any links to the multiple subordinate directories for records of users of mobile radio devices being within the geographic area.
